(19) United States
(12) Patent Application Publication
(10) Pub. No.: US 2024/0020490 A1
(43) Pub. Date: Jan. 18, 2024

(54) METHOD AND APPARATUS FOR PROCESSING TRANSLATION

(71) Applicant: SAMSUNG ELECTRONICS CO., LTD., Suwon-shi (KR)

(72) Inventors: Hoseon SHIN, Suwon-shi (KR); Chulmin LEE, Suwon-shi (KR); Youngwoo LEE, Suwon-shi (KR)

(73) Assignee: SAMSUNG ELECTRONICS CO., LTD., Suwon-shi (KR)

(21) Appl. No.: 18/237,158

(22) Filed: Aug. 23, 2023

Related U.S. Application Data
(63) Continuation of application No. PCT/KR23/09941, filed on Jul. 12, 2023.

(30) Foreign Application Priority Data
Jul. 12, 2022 (KR) 10-2022-0085828
Sep. 2, 2022 (KR) 10-2022-0111527

(51) Int. Cl. G06F 40/58; G06V 20/50; G10L 15/22; G10L 15/26; G10L 15/30; G10L 21/0216; G06V 40/16; G10L 15/25

(52) U.S. Cl. CPC G06F 40/58; G06V 20/50; G10L 15/22; G10L 15/26; G10L 15/30; G10L 21/0216; G06V 40/166; G10L 15/25; G10L 2021/02082

(57) ABSTRACT

An electronic device includes a processor configured to: acquire first audio a microphone being connected with an external device through a communication module; generate first audio data by cancelling an echo from the acquired first audio; transmit the first audio data to an external device; receive at least one of second audio or second audio data, the second audio or the second audio data being acquired through a microphone of the external device from the external device; translate the first audio data and obtain first translation information; translate the second audio data and obtain second translation information; transmit the first translation information to the external device; and output the second translation information.

### CROSS-REFERENCE TO RELATED APPLICATIONS

This application is a by-pass continuation application of International Application No. PCT/KR2023/009941, filed on Jul. 12, 2023, which is based on and claims priority to Korean Patent Application Nos. 10-2022-0085828, filed on Jul. 12, 2022, and 10-2022-0111527, filed on Sep. 2, 2022, in the Korean Intellectual Property Office, the disclosures of which are incorporated by reference herein their entireties.

### BACKGROUND

### 1. Field

The disclosure relates to a method and an apparatus for processing translation.

### 2. Description of Related Art

With the development of digital technologies, various types of electronic devices such as mobile communication terminals, personal digital assistants (PDAs), electronic organizers, smartphones, tablet personal computers (PCs), and wearable devices have become widely used. The hardware parts and/or software parts of such electronic devices are continually improving in order to improve support and increase functions thereof.

For example, the electronic device may be connected to a notebook, a wireless input/output device (for example, earphones or headphone), or a wearable display device through short-range wireless communication such as Bluetooth or Wi-Fi direct to output or exchange information or content. For example, the electronic device may be connected to the wireless input/output device through short-range communication to output music or a sound of a video through the wireless input/output device.

When a user meets a foreigner (a counterpart), the electronic device may provide a translation service to make conversation convenient.

An electronic device may be connected to a wireless input/output device (for example, wireless earphones) through short-range communication, and a translation service can be used in the state in which a user is wearing the wireless input/output device. After translating each of a voice of the user wearing the wireless input/output device and a voice of a foreigner (for example, a counterpart) who is not wearing the wireless input/output device, the electronic device may output a first translation voice obtained by translating the voice of the foreigner through the wireless input/output device and output a second translation voice obtained by translating the voice of the user through a speaker of the electronic device.

At this time, the user may start speaking again while the first translation voice is output, and the counterpart may also start speaking again while the second translation voice is output. In this case, since the first translation voice overlaps the voice of the user, the electronic device may not separately translate the first translation voice and the user's voice. Alternatively, when the user starts speaking again after each of the translation voices is output, it may take a longer time to wait for the speaking.

### SUMMARY

One or more embodiments may disclose a method and an apparatus for, when a user and a foreigner talk to each other, processing translation capable of solving a problem that the electronic device cannot translate or waiting time becomes longer and separately translating the voice of the user and the voice of the foreigner.

The technical subjects pursued in the disclosure are not limited to the above mentioned technical subjects, and other technical subjects which are not mentioned may be clearly understood through the following descriptions by those skilled in the art of the disclosure.

According to an aspect of the disclosure, an electronic device includes: at least one microphone; at least one speaker; a communication module; a display; a memory; and a processor operatively connected to at least one of the at least one microphone, the at least one speaker, the communication module, the display, or the memory. The processor is configured to: acquire first audio through the at least one microphone being connected with an external device through the communication module; generate first audio data by cancelling an echo from the acquired first audio; transmit the first audio data to the external device; receive at least one of second audio or second audio data, the second audio or the second audio data being acquired through a microphone of the external device from the external device; translate the first audio data and obtain first translation information; translate the second audio data and obtain second translation information; transmit the first translation information to the external device; and output the second translation information.

According to another aspect of the disclosure, a method of operating an electronic device, includes: acquiring first audio through the at least one microphone of the electronic device being connected with an external device through the communication module of the electronic device; generating first audio data by cancelling an echo from the acquired first audio; transmitting the first audio data to the external device; receiving at least one of second audio or second audio data, the second audio or the second audio data being acquired through a microphone of the external device from the external device; translating each of the first audio data and the second audio data; and transmitting first translation information obtained by translating the first audio data to the external device and outputting second translation information obtained by translating the second audio data.

According to an embodiment, when the electronic device provides a translation service in the state in which the electronic device is connected to the wireless input/output device, it is possible to separately translate a user's voice and a counterpart's voice even when the user's voice and the translated counterpart's voice overlap each other or the counterpart's voice and the translated user's voice overlap each other.

According to an embodiment, it may be possible to process sounds (for example, the counterpart's voice and surrounding noise) except for the user's voice input into the wireless input/output device as noise and cancelling the noise and process sounds (for example, the user's voice and surrounding noise) except for the counterpart's voice input into the electronic device as noise and cancelling the noise by exchanging the user's voice and the counterpart's voice acquired from the electronic device and the wireless input/output device.

According to an embodiment, the volume of the user's voice input through a microphone of the wireless input/output device is higher than the volume of the counterpart's voice and the counterpart's voice input through a microphone of the electronic device is higher than the volume of the user's voice due to distance difference between the electronic device and the wireless input/output device, and thus it is possible to effectively preprocess the user's voice and the counterpart's voice on the basis of the volume.

According to an embodiment, even though the user and the counterpart simultaneously speak or the user or the counterpart speaks while a translated voice is output, it is possible to improve user convenience by accurately translating only the user's voice or the counterpart's voice.

The effects that can be realized by the disclosure are not limited to the above-described effects, and other effects that have not been mentioned may be clearly understood by those skilled in the art from the following description.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device within a network environment according to an embodiment of the disclosure;

FIG. 2 illustrates an example of providing a translation service in the state in which an electronic device and a wireless input/output device are connected according to an embodiment of the disclosure;

FIG. 3A illustrates a configuration related to translation of an electronic device and a wireless input/output device according to an embodiment of the disclosure;

FIG. 3B illustrates a configuration related to translation of an electronic device and a wireless input/output device according to an embodiment of the disclosure;

FIG. 3C illustrates a configuration related to translation of an electronic device according to an embodiment of the disclosure;

FIG. 4 is a flowchart illustrating a method of providing a translation service in the state in which an electronic device and a wireless input/output device are connected according to an embodiment of the disclosure;

FIG. 5A illustrates an example in which each of an electronic device and a wireless input/output device acquires a voice according to an embodiment of the disclosure;

FIG. 5B illustrates an example in which each of an electronic device and a wireless input/output device acquires and outputs a voice according to an embodiment of the disclosure;

FIG. 6 is a flowchart illustrating a method of operating an electronic device according to an embodiment of the disclosure;

FIG. 7 illustrates an example in which an electronic device preprocesses and translates a counterpart's voice according to an embodiment of the disclosure;

FIG. 8 is a flowchart illustrating a method of operating a wireless input/output device according to an embodiment of the disclosure;

FIG. 9 illustrates an example in which a wireless input/output device preprocesses and translates a user's voice according to an embodiment of the disclosure;

FIGS. 10A and 10B illustrate user interfaces provided by an electronic device according to an embodiment of the disclosure; and

FIG. 11 is a flowchart illustrating a method by which an electronic device acquires and translates a user's voice and a counterpart's voice according to an embodiment of the disclosure.

### DETAILED DESCRIPTION

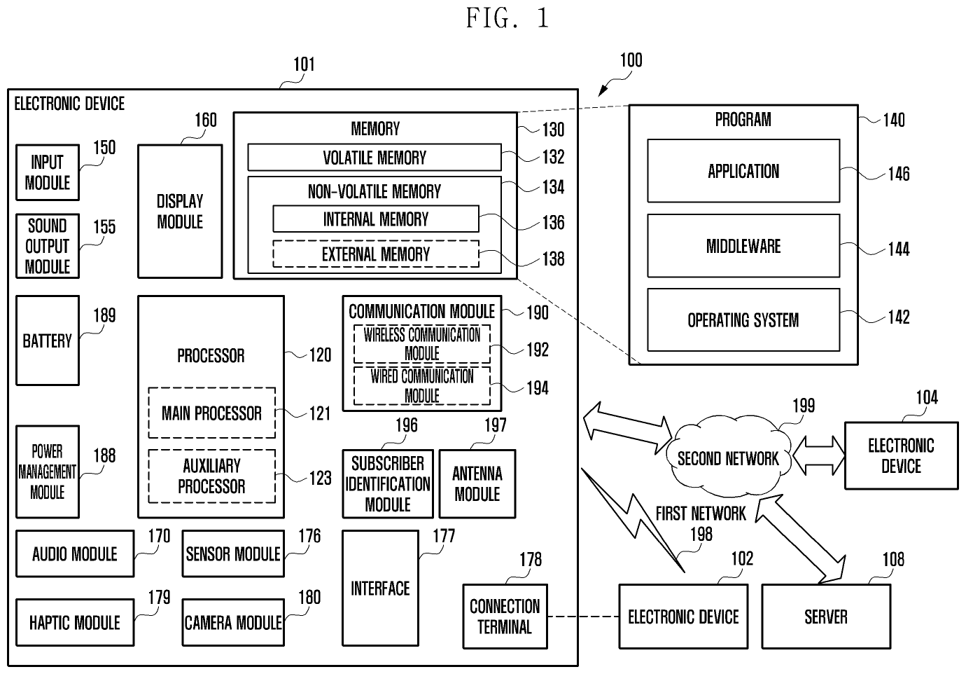

FIG. 1 is a block diagram illustrating an electronic device 101 in a network environment 100 according to certain embodiments.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5th generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4th generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to certain embodiments, the antenna module 197 may form a mmWave antenna module. According to an embodiment, the mmWave antenna module may include a printed circuit board, an RFIC disposed on a first surface (e.g., the bottom surface) of the PCB, or adjacent to the first surface and capable of supporting a designated high-frequency band (e.g., the mmWave band), and a plurality of antennas (e.g., array antennas) disposed on a second surface (e.g., the top or a side surface) of the PCB, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

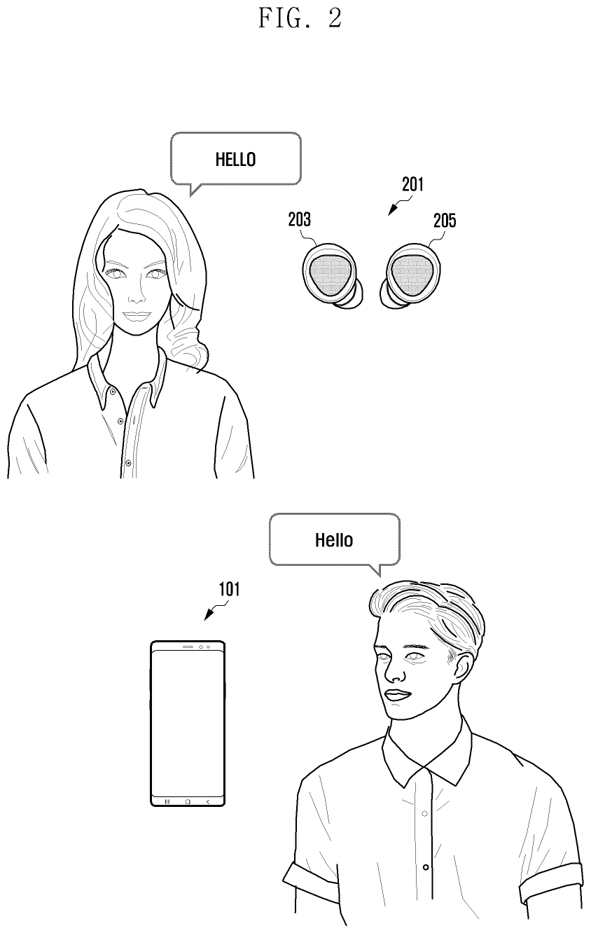

FIG. 2 illustrates an example of providing a translation service in the state in which an electronic device and a wireless input/output device are connected according to an embodiment of the disclosure.

Referring to FIG. 2, an electronic device (for example, the electronic device 101 of FIG. 1) according to an embodiment may provide a translation service for conversation between a user and a counterpart (for example, a foreigner) in the state in which the electronic device is connected to a wireless input/output device 201. The user (for example, a woman in the figure) is wearing the wireless input/output device 201 and the counterpart (for example, a man in the figure) may be located near the electronic device 101 without wearing the wireless input/output device. The wireless input/output device 201 may be a device which is wirelessly connected to the electronic device 101 such as earphones or headphone which can be worn on both ears. For the wireless input/output device 210, a first device 203 and a second device 205 may operate as a pair, and each device may include a processor, a communication module, a sensor module (for example, a proximity sensor, a touch sensor, or the like), a microphone, and a speaker.

According to an embodiment, the user may execute an application (for example, the application 146 of FIG. 1) for the translation service included in the electronic device 101 in the state in which the user is wearing the wireless input/output device 201. When the electronic device 101 is connected to (for example, paired with) the wireless input/output device 201, the electronic device 101 may recognize (or process) a sound acquired (received or input) by the microphone (for example, a first microphone) (for example, the input module 150 of FIG. 1) of the electronic device 101 as a counterpart's voice and process a sound acquired by the microphone (for example, a second microphone) of the wireless input/output device 201 as a user's voice. The electronic device 101 may be paired with the wireless input/output device 201 through short-range wireless communication (for example, Bluetooth). In order to distinguish between the microphone of the electronic device 101 and the microphone of the wireless input/output device 201, it may be described that the microphone of the electronic device 101 is the first microphone and the microphone of the wireless input/output device 201 is the second microphone. The number of first microphones or second microphones may be one or plural.

Hereinafter, the counterpart's voice acquired through the first microphone of the electronic device 101 is named first audio, and the user's voice acquired through the second microphone of the wireless input/output device 201 is named second audio. For example, the first audio may include a counterpart's voice, a user's voice, surrounding noise, and a sound output from the speaker (for example, a first speaker) (for example, the sound output module 155 of FIG. 1) of the electronic device 101. The second audio may include a counterpart's voice, a user's voice, surrounding noise, and a sound output from the speaker (for example, a second speaker) of the wireless input/output device 201. The first audio may be stored in an audio buffer (For example, the memory 130 of FIG. 1) of the electronic device 101, and the second audio may be stored in an audio buffer of the wireless input/output device 201. The electronic device 101 and the wireless input/output device 201 may exchange (or share) the audio (for example, the first audio and the second audio) stored in the audio buffers, so as to process the audio signals.

According to an embodiment, although the wireless input/output device 201 and the electronic device 101 are separated from each other, if the separation distance is not sufficient, some of the user's voice may flow into the first microphone of the electronic device 101 and some of the counterpart's voice may flow into the second microphone of the wireless input/output device 201. Alternatively, the sound being output through the first speaker of the electronic device 101 may flow into the first microphone of the electronic device 101 or the second microphone of the wireless input/output device 201. Further, the sound being output through the second speaker of the wireless input/output device 201 may flow into the second microphone of the wireless input/output device 201.

According to an embodiment, the electronic device 101 may apply (or process) an acoustic echo canceller (AEC) to the first audio and transmit first audio data (or audio signal) from which at least some echoes are cancelled to the wireless input/output device 201. The AEC may be an algorithm or software for canceling echo. The electronic device 101 may input the sound being output through the first speaker to the AEC as a first audio reference and cancel at least some of the sound being output through the first speaker from the first audio. The electronic device 101 may acquire second audio or second audio data from the wireless input/output device 201. The second audio data may be audio data obtained by applying the AEC to the second audio. The second audio may be audio (for example, raw data) in which the AEC is not processed. When receiving the second audio in which the AEC is not processed, the electronic device 101 may generate the second audio data from which at least some echoes are cancelled by processing the AEC.

According to an embodiment, the electronic device 101 may preprocess the first audio data on the basis of the second audio data (or audio signal). The preprocessing may be processing that makes only a relatively clear (or improved) counterpart's voice left by cancelling at least some of all sounds (for example, noise) except for the counterpart's voice from the first audio data. For relatively accurate translation processing, it may be important to make other sounds except for the counterpart's voice not be included. The electronic device 101 may extract the counterpart's voice improved through preprocessing of the first audio data as a first target voice. The electronic device 101 may extract the first target voice by using a technology such as machine learning or deep learning.

According to an embodiment, the electronic device 101 may detect the start (for example, a start time point or a start time) and the end (for example, an end time point or an end time) of the first target voice by processing voice activity detection (VAD) for the extracted first target voice. The VAD may be an algorithm or software for detecting the start of the first target voice and the end of the first target voice. According to an embodiment, the electronic device 101 may capture the counterpart through a camera module (for example, the camera module 180 of FIG. 1) and analyze lip reading of the captured counterpart image, so as to detect the start of the first target voice and the end of the first target voice. The lip reading may be a technology for inferring user speaking by analyzing movement of the user's lip. The electronic device 101 may transfer the first target voice and the start of the first target voice and the end of the first target voice to automatic speech recognition (ASR). The ASR may be an algorithm or software for recognizing the first target voice (for example, an acoustic speech signal) and converting the same into text (for example, words or sentences).

According to an embodiment, the electronic device 101 may perform ASR on the first target voice on the basis of the start of the first target voice and the end of the first target voice and translate first text for which the ASR has been performed. When processing the ASR on the first target voice, the electronic device 101 may acquire first text corresponding to the first target voice. The electronic device 101 may translation-process the first text and acquire first translation information (or first translation data). The electronic device 101 may transmit the first translation information to the wireless input/output device 201. The electronic device 101 may perform text to speech (TTS) conversion for the first translation information and transmit the same to the wireless input/output device 201. The electronic device 101 may display the first translation information on a display (for example, the display module 160 of FIG. 1).

According to an embodiment, the wireless input/output device 201 may apply (or process) AEC to the second audio and transmit second audio data from which at least some echoes are cancelled to the electronic device 101. The wireless input/output device 201 may input a sound being output through the second speaker to the AEC as a second audio reference and remove the sound being output through the second speaker from the second audio. The wireless input/output device 201 may receive the first audio data from the electronic device 101 and preprocess the second audio data on the basis of the first audio data. The wireless input/output device 201 may extract a user's voice improved by preprocessing the second audio data as a second target voice and transmit the extracted second target voice to the electronic device 101. The wireless input/output device 201 may process VAD for the extracted second target voice and detect the start of the second target voice and the end of the second target voice. The wireless input/output device 201 may transmit information on the start of the second target voice and the end of the second target voice to the electronic device 101.

According to an embodiment, the electronic device 101 may receive the second target voice and the information on the start of the second target voice and the end of the second target voice from the wireless input/output device 201. The electronic device 101 may perform ASR on the second target voice on the basis of the information on the start of the second target voice and the end of the second target voice and translate a second text on which the ASR is performed. When processing the ASR on the second target voice, the electronic device 101 may acquire the second text corresponding to the second target voice. The electronic device 101 may translation-process the second text and acquire second translation information (or second translation data). The electronic device 101 may perform TTS conversion for the second translation information and output the same through the first speaker or display the second translation information on the display module 160.

According to an embodiment, the electronic device 101 may acquire a new counterpart's voice (for example, third audio) while the wireless input/output device 201 outputs translation information (for example, first translation information) corresponding to a counterpart's voice (for example, first audio). Further, the electronic device 101 may output translation information (for example, second translation information) corresponding to a previous user's voice (for example, second audio) while the wireless input/output device 201 acquires a new user's voice (for example, fourth audio). That is, even though the input voice (for example, the user's voice or the counterpart's voice) and the translated voice (for example, the translated voice corresponding to the user's voice or the translated voice corresponding to the counterpart's voice) overlap, the electronic device 101 and the wireless input/output device 201 may separate and translate only the user's voice and separate and translate only the counterpart's voice. This will be described in detail with reference to the following drawings.

According to an embodiment, the translation service may be provided in the state in which the electronic device 101 and the wireless input/output device 201 are not connected. The state in which the electronic device 101 and the wireless input/output device 201 are not connected may be the state in which the electronic device 101 and the wireless input/output device 201 are not connected (for example, not paired) through short-range wireless communication. In this case, the electronic device 101 may provide the translation service through a directional microphone and a plurality of speakers. A first microphone and a first speaker may be disposed on one end of the electronic device 101 (for example, the location in which the camera is positioned) from the front of the electronic device 101 on which the display of the electronic device 101 is disposed, and a second microphone and a second speaker may be disposed on the other end of the electronic device 101 (for example, the location to which a charger is connected). The electronic device 101 may acquire first audio (for example, a user's voice or a counterpart's voice), determine a directional microphone on the basis of the acquired first audio, and process a voice acquired through another microphone (for example, the first microphone) except for the determined microphone (for example, the second microphone) as second audio.

For example, the first microphone and the first speaker may be used to receive the counterpart's voice or output a voice to the counterpart, and the second microphone and the second speaker may be used to receive the user's voice or output a voice to the user. The electronic device 101 may translate a counterpart's voice input through the first microphone and output the translated counterpart's voice through the second speaker. The electronic device 101 may translate a user's voice input through the second microphone and output the translated user's voice through the first speaker. The electronic device 101 may cancel at least some echoes from the counterpart's voice or the user's voice and preprocess and translate the voice.

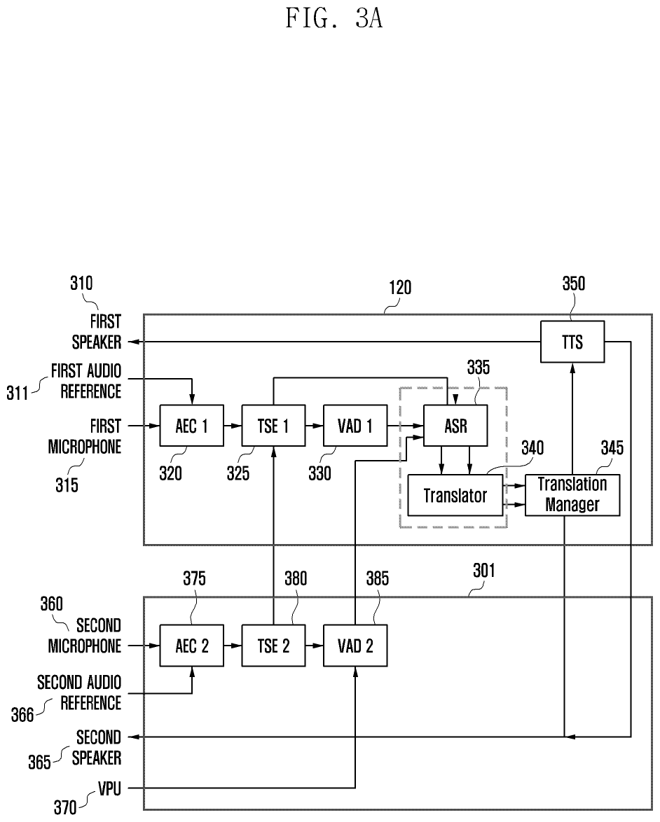

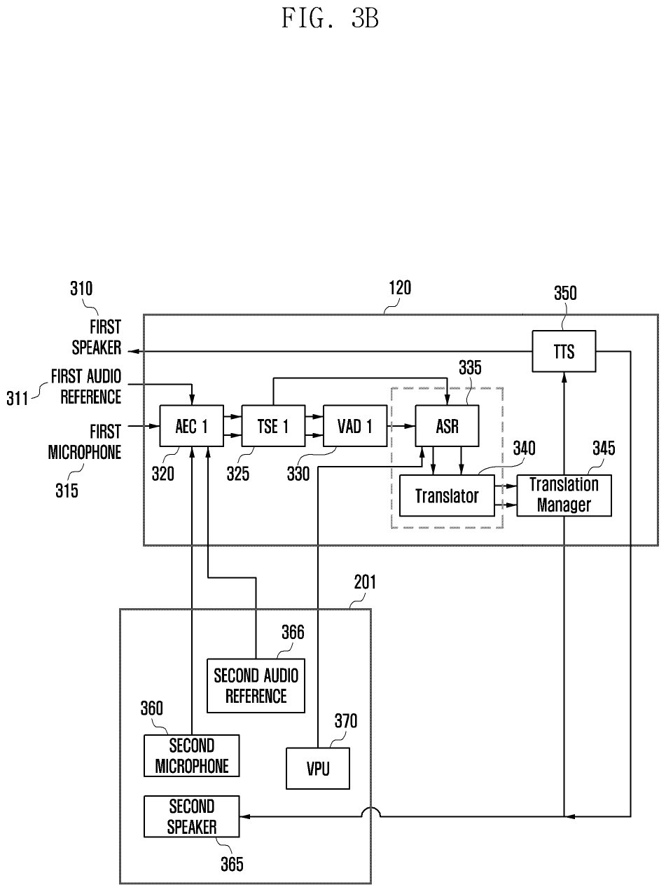

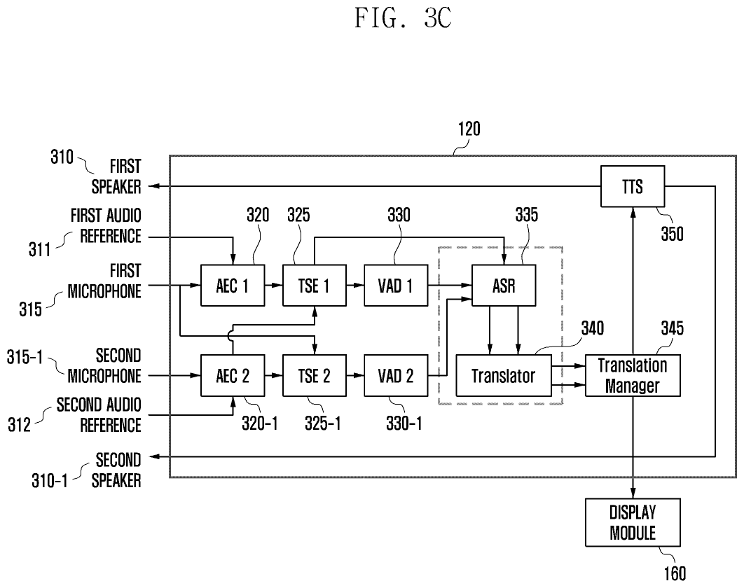

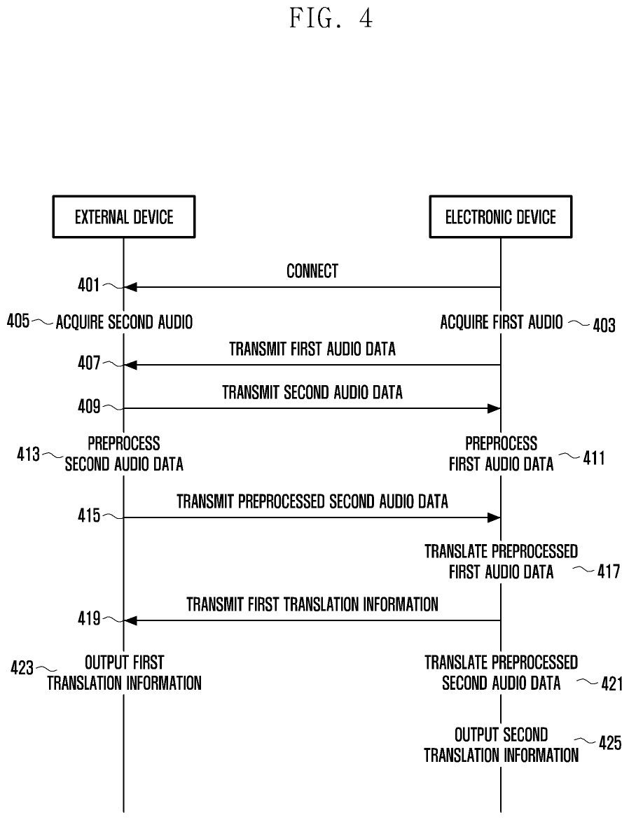

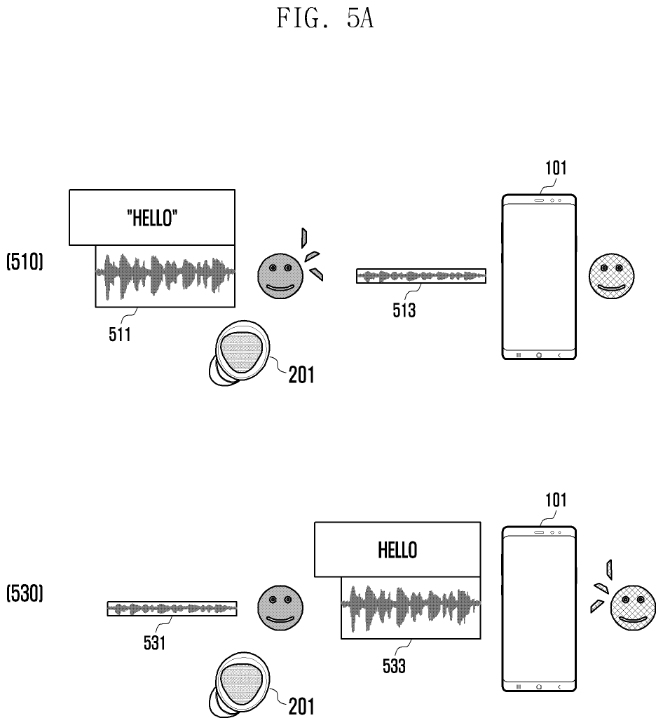

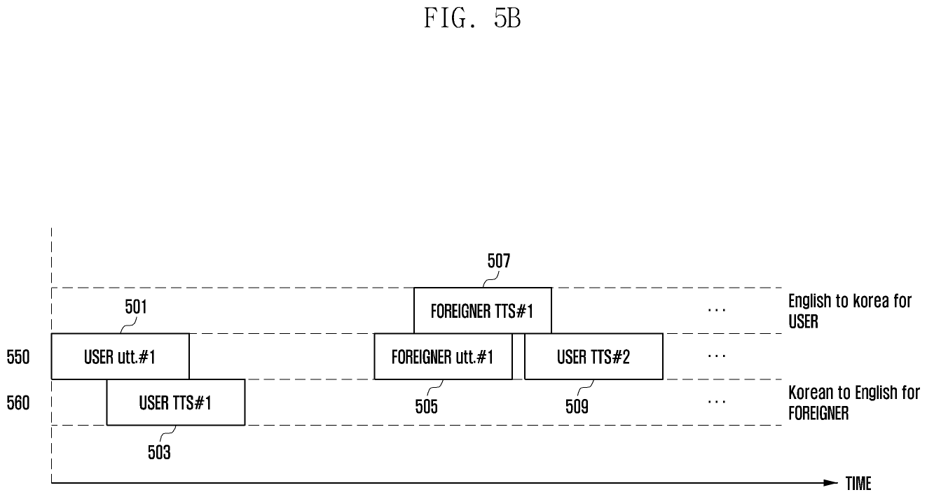

FIG. 3A illustrates a configuration related to translation of an electronic device and a wireless input/output device according to an embodiment of the disclosure.

Referring to FIG. 3A, an electronic device (for example, the electronic device 101 of FIG. 1) according to an embodiment may include at least one of a processor (for example, the processor 120 of FIG. 1), a first speaker 310 (for example, the sound output module 155 of FIG. 1), or a first microphone 315 (for example, the input module 150 of FIG. 1) in connection with translation. The electronic device 101 may further include a communication module (For example, the communication module 190 of FIG. 1) and a display (For example, the display module 160 of FIG. 1) in connection with translation. The processor 120 may internally include an algorithm or software related to at least one of AEC 1 320, target speaker extractor (TSE) 1 325, VAD 1 330, ASR 335, a translator 340, a translation manager 345, or TTS 350. AEC 1 320, TSE 1 325, and VAD 1 330 may be preprocessing of an audio signal (or data). The ASR 335 and the translator 340 may be separately configured or may be configured as a single module.

According to an embodiment, the first microphone 315 may acquire the counterpart's voice as first audio and transfer the acquired first audio to AEC 1 320. The first audio may be stored in an audio buffer (for example, the memory 130 of FIG. 1). AEC 1 320 may cancel at least some echoes from the first audio and transfer first audio data from which at least some echoes are cancelled to TSE 1 325. The first audio may include a counterpart's voice, a user's voice, surrounding noise, and/or a sound output from the first speaker 310. AEC 1 320 may use the sound output through the first speaker 310 as a first audio reference 311. When there is a sound (for example, a voice translated for a user's voice, music, and/or a notification sound) being output through the first speaker 310, some of the sound being output through the first speaker 310 may flow into the first microphone 315. There may be a time difference until the sound output from the first speaker 310 is input into the first microphone 315. AEC 1 320 may cancel at least some of the sound output from the first speaker 310 from the first audio on the basis of the first audio reference. Further, AEC 1 320 may cancel at least some of the surrounding noise from the first audio.

According to an embodiment, TSE 1 325 may extract (generate or identify) a first target voice from the first audio data. The first target voice may include only an improved counterpart's voice and be a voice from which at least some of the sounds except for the counterpart's voice (for example, a user's voice) are cancelled. TSE 1 325 may extract the first target voice on the basis of second audio data received from the wireless input/output device (for example, the wireless input/output device 201 of FIG. 2). The second audio data is the user's voice, and thus TSE 1 325 may extract the first target voice by cancelling at least some of the user's voice from the counterpart's voice. Alternatively, the memory (for example, the memory 130 of FIG. 1) may store user's voice information of the electronic device 101 (for example, an audio file or voice characteristic information related to the user's voice). TSE 1 325 may extract the first target voice on the basis of the user's voice information stored in the memory 130.

According to the disclosure, the electronic device 101 may separate and translate only the counterpart's voice from a sound corresponding to a combination (or overlapping) of a plurality of sounds by extracting the counterpart's voice acquired during the output of the translated user's voice through the first speaker as the first target voice, thereby processing relatively accurate translation. TSE 1 325 may transfer the first target voice to VAD 1 330 and the ASR 335. VAD 1 330 may detect the start of the first target voice and the end of the first target voice. VAD 1 330 may transfer the detected start and end of the first target voice to the ASR 335.

According to an embodiment, the ASR 335 may recognize the first target voice on the basis of the start of the first target voice and the end of the first target voice. The ASR 335 may recognize the first target voice and generate first translation information. The first translation information may be text. The ASR 335 may transfer the first translation information to the translation manager 345 via the translator 340. The translation manager 345 may transfer the first translation information to the TTS 350 or the display module 160 in order to output the same. The TTS 350 may convert the first translation information into a first translation voice and transfer the first translation voice to the communication module 190. The communication module 190 may transmit the first translation voice to the wireless input/output device 201. The display module 160 may display the first translation information.

The wireless input/output device 201 according to an embodiment may include at least one of a second processor 301, a second speaker 365 (for example, the sound output module 155), a second microphone 360, and a voice pick-up (VPU) sensor 370 in connection with translation. The wireless input/output device 210 may include a first device worn on a left ear of the user and a second device worn on a right ear of the user. The configuration related to translation of the wireless input/output device 201 may be included in the first device or the second device. The electronic device 101 may further include a second communication module (for example, the communication module 190 of FIG. 1), a sensor module (for example, a touch sensor or a proximity sensor), or an LED module in connection with translation. The second processor 301 may internally include an algorithm or software related to at least one of AEC 2 375, TSE 2 380, or VAD 2 385.

In the drawings, numbers 1 and 2 or the first and second may be used to distinguish the elements (for example, the first speaker 310 and AEC 1 320) included in the electronic device 101 from the elements (for example, the second speaker 365 and AEC 2 375) included in the wireless input/output device 201. The first speaker 310 or the second speaker 365 may play the same role but may have different performance (for example, hardware) or algorithms (for example, software).

According to an embodiment, the second microphone 360 may acquire a user's voice as second audio and transfer the acquired second audio to AEC 2 375. The second audio may be stored in a second audio buffer of the wireless input/output device 201. AEC 2 375 may cancel at least some echoes from the second audio and transfer second audio data from which at least some echoes are cancelled to TSE 2 380. The second audio may include a counterpart's voice, a user's voice, surrounding noise, a sound output from the first speaker 310, and/or a sound output from the second speaker 365. AEC 2 375 may use the sound output from the first speaker 310 and/or the sound output from the second speaker 365 as a second audio reference. Some of the sound output from the first speaker 310 (for example, a voice translated for the user's voice) or the sound being output through the second speaker 365 (for example, a voice translated for the counterpart's voice, music, and/or a notification sound) may flow into the second microphone 360. There may be a time difference until the sound output from the first speaker 310 or the sound being output through the second speaker 365 is input into the second microphone 360. AEC 2 375 may cancel at least some of the sound output from the first speaker 310 and the sound being output through the second speaker 365 from the second audio on the basis of the second audio reference.

According to an embodiment, TSE 2 380 may extract (or generate) a second target voice from the second audio data. The second target voice includes only an improved user's voice and may be a voice from which at least some of the sounds except for the user's voice are cancelled. TSE 2 380 may extract the second target voice on the basis of the first audio data received from the electronic device 101. Since the first audio data is the counterpart's voice, TSF 2 380 may extract the second target voice by cancelling at least some of the counterpart's voice from the user's voice. TSE 2 380 may transfer the second target voice to VAD 2 385 and a second communication module.

According to an embodiment, VAD 2 385 may detect the start of the second target voice and the end of the second target voice. The VPU sensor 370 may detect the start and the end of second audio on the basis of vibration generated when the second audio is acquired through a bone conduction sensor. When the user wears the wireless input/output device 201, vibration may be generated when the user speaks. The VPU sensor 370 may transfer the start and the end of the second audio to VAD 2 385. VAD 2 385 may detect the start of the second target voice and the end of the second target voice on the basis of the start and the end of the second audio received from the VPU sensor 370. VAD 2 385 may transfer the start of the second target voice and the end of the second target voice to the second communication module.

According to an embodiment, the second communication module may transmit the second target voice and the start of the second target voice and the end of the second target voice to the electronic device 101. Further, the second communication module may receive a first translation voice corresponding to the first target voice from the electronic device 101. The second communication module may transfer the received first translation voice to the second speaker 365. The second speaker 365 may output the first translation voice. The user wearing the wireless input/output device 201 may listen to the first translation voice output through the second speaker 365.

According to an embodiment, the ASR 335 may recognize the second target voice on the basis of the start of the second target voice and the end of the second target voice. The ASR 335 may recognize the second target voice and generate second translation information. The second translation information may be text. The ASR 335 may transfer the second translation information to the translation manager 345 via the translator 340. The translation manager 345 may transfer the second translation information to the TTS 350 or the display module 160 in order to output the same. The TTS 350 may convert the second translation information into a second translation voice and transfer the second translation voice to the first speaker 310. The first speaker 310 may output the second translation voice. The display module 160 may display the second translation information.

According to an embodiment, the electronic device 101 and the wireless input/output device 201 may exchange (or share) audio (for example, first audio and second audio) stored in the audio buffers, so as to process audio signals. When language of the user wearing the wireless input/output device 201 is ‘Korean’ and language of the counterpart is ‘English’, the first translation information may be Korean (for example, Hello?) and the second translation information may be English (for example, Hello). The user wearing the wireless input/output device 201 speaks in Korean, and speaking of the counterpart may be translated into Korean and then output. The counterpart close to the electronic device 101 speaks in English, and speaking of the user is translated into English and output in the form of a voice through the first speaker 310 or displayed in text on the display module 160.

FIG. 3B illustrates a configuration related to translation of an electronic device and a wireless input/output device according to an embodiment of the disclosure.

Referring to FIG. 3B, the wireless input/output device 201 may include the second microphone 360, the second speaker 365, and the VPU sensor 370, and may not include the configuration related to translation (for example, AEC 2 375, TSE 2 380, or VAD 2 385 of FIG. 3A). The electronic device 101 may acquire audio from the wireless input/output device 201 and perform an operation related to translation for a user's voice and a counterpart's voice. In the drawings, the processor 120 includes AEC 1 320, TSE 1 325, and VAD 1 330, but may further include an element for processing audio acquired from the wireless input/output device 201. That is, the processor 120 may include two AECs, two TSEs, and two VADs. For example, the processor 120 may include an element (for example, AEC1 320, TSE 1 325, and VAD 1 330) for processing a user's voice and an element (for example, AEC 2 320-1, TSE 2 325-1, and VAD 2 330-1) for processing a counterpart's voice. Since the elements of FIG. 3B are the same as or similar to those of FIG. 3A, a detailed description thereof may be omitted.

According to an embodiment, the first microphone 315 may acquire the counterpart's voice as first audio and transfer the acquired first audio to AEC 1 320. AEC 1 320 may cancel at least some echoes from the first audio and transfer first audio data from which at least some echoes are cancelled to TSE 1 325. TSE 1 325 may extract (or generate) a first target voice from the first audio data. The first target voice may include only an improved counterpart's voice and be a voice from which at least some of the sounds except for the counterpart's voice (for example, a user's voice) are cancelled. TSE 1 325 may transfer the first target voice to VAD 1 330 and the ASR 335. VAD 1 330 may detect the start of the first target voice and the end of the first target voice. VAD 1 330 may transfer the start and the end of the detected first target voice to the ASR 335.

According to an embodiment, the second microphone 360 of the wireless input/output device 201 may acquire second audio. AEC 1 320 may receive the second audio through the communication module 190. AEC 1 320 may cancel at least some echoes from the second audio and transfer second audio data from which at least some echoes are cancelled to TSE 1 325. TSE 1 325 may extract (or generate) a second target voice from the second audio data. The second target voice includes only an improved user's voice and may be a voice from which at least some of the sounds except for the user's voice are cancelled. The VPU sensor 370 of the wireless input/output device 201 may detect the start and the end of the second audio and transmit the start and the end to the electronic device 101. TSE 1 325 may receive the start and the end of the second audio from the VPU sensor 370 through the communication module 190. TSE 1 325 may transfer the second target voice to VAD 1 330 and the ASR 335. VAD 1 330 may detect the start of the second target voice and the end of the second target voice on the basis of the start and the end of the second audio. VAD 1 330 may transfer the detected start and end of the second target voice to the ASR 335.

According to an embodiment, the ASR 335 may recognize the first target voice on the basis of the start of the first target voice and the end of the first target voice. The ASR 335 may recognize the first target voice and generate first translation information. The first translation information may be text. The ASR 335 may transfer the first translation information to the translation manager 345 via the translator 340. The translation manager 345 may transfer the first translation information to the TTS 350 or the display module 160 in order to output the same. The TTS 350 may convert the first translation information into a first translation voice and transfer the same to the communication module 190. The communication module 190 may transmit the first translation voice to the wireless input/output device 201. The second speaker 365 of the wireless input/output device 201 may output the first translation voice. The display module 160 may display the first translation information.

According to an embodiment, the ASR 335 may recognize the second target voice on the basis of the start of the second target voice and the end of the second target voice. The ASR 335 may recognize the second target voice and generate second translation information. The second translation information may be text. The ASR 335 may transfer the second translation information to the translation manager 345 via the translator 340. The translation manager 345 may transfer the second translation information to the TTS 350 or the display module 160 in order to output the same. The TTS 350 may convert the second translation information into a second translation voice and transfer the second translation voice to the first speaker 310. The first speaker 310 may output the second translation voice. The display module 160 may display the second translation information.

FIG. 3C illustrates a configuration related to translation of an electronic device according to an embodiment of the disclosure.

Referring to FIG. 3C, when the electronic device 101 provides a translation service in the state in which the electronic device 101 is not connected to the wireless input/output device 201, the electronic device 101 may include at least one of the processor 120, the first speaker 310, a second speaker 310-1, the first microphone 315, or a second microphone 315-1 in connection with translation. The first speaker 310 and the first microphone 315 may be disposed at substantially similar locations, and the second speaker 310-1 and the second microphone 315-1 may be disposed at separated locations. For example, the first speaker 310 and the first microphone 315 may be disposed on one end of the electronic device 101 (for example, a direction in which the camera is disposed) from the front of the electronic device 101 on which a display (for example, the display module 160 of FIG. 1) of the electronic device 101 is disposed, and the second speaker 310-1 and the second microphone 315-1 may be disposed on the other end of the electronic device 101 (for example, a direction to which a charger is connected). Alternatively, the first speaker 310 and the first microphone 315 may be disposed on one side of the electronic device 101 (for example, the left side in a viewpoint of the user viewing the electronic device 101) from the front of the electronic device 101, and the second speaker 310-1 and the second microphone 315-1 may be disposed on the other side (for example, the right side) of the electronic device 101.

According to an embodiment, the processor 120 may internally include an algorithm or software related to at least one of AEC 1 320, AEC 2 320-1, TSE 1 325, TSE 2 325-1, VAD 1 330, VAD 2 330-1, the ASR 335, the translator 340, the translation manager 345, or the TTS 350. That is, the processor 120 may include the element (for example, AEC 1 320, TSE 1 325, and VAD 1 330) for processing the user's voice and the element (for example, AEC 2 320-1, TSE 2 325-1, and VAD 2 330-1) for processing the counterpart's voice. Since elements of FIG. 3C are the same as or similar to those of FIG. 3A, a detailed description thereof is omitted. In the drawings, the electronic device 101 includes two microphones and two speakers, but may include microphones and speakers larger than two. The drawings are only for helping understanding of the disclosure, and the disclosure is not limited by the drawings or the description.

According to an embodiment, the processor 120 may acquire first audio from the first microphone 315 or the second microphone 315-1. The first audio may be a user's voice or a counterpart's voice. A memory (for example, the memory 130 of FIG. 1) may store user's voice information (for example, an audio file or voice characteristic information related to the user's voice) of the electronic device 101. The processor 120 may determine whether the first audio is a user's voice or a counterpart's voice on the basis of the user's voice information stored in the memory 130. Hereinafter, it is described that the first audio is a voice acquired from the counterpart in consideration of the description made with reference to FIGS. 3A and 3B. The processor 120 may determine a microphone directing at the first audio on the basis of the volume of the first audio acquired from the first microphone 315 and the volume of the first audio acquired from the second microphone 315-1. The volume of the sound acquired from each microphone may be different according to the location (or existence) of the microphone close to the counterpart or the user.

For example, when the counterpart is located closer to the first microphone 315 than the second microphone 315-1, the volume of a first audio signal acquired from the first microphone 315 may be larger than the volume of a first audio signal acquired from the second microphone 315-1. The processor 120 may determine the microphone directing at the first audio as the first microphone 315 on the basis of the volume of the first audio acquired from the first microphone 315 and the volume of the first audio acquired from the second microphone 315-1. In this case, the processor 120 may determine a directional microphone of second audio having a voice characteristic different from that of the first audio as the second microphone 315-1. Hereinafter, it will be described that the counterpart is located closer to the first speaker 310 and the first microphone 315 than the user is, and the user is located closer to the second speaker 310-1 and the second microphone 315-1 than the counterpart is.

According to an embodiment, AEC 1 320 may cancel at least some echoes from the first audio and transfer first audio data from which at least some echoes to TSE 1 325. TSE 1 325 may extract (or generate) a first target voice from the first audio data. The first target voice includes only an improved counterpart's voice and may be a voice from which at least some of the sounds except for the counterpart's voice (for example, surrounding noise and the user's voice) are cancelled. TSE 1 325 may extract the first target voice on the basis of second audio data acquired through the second microphone 315-1. The second audio data may be generated by applying AEC 2 320-1 to the second audio acquired through the second microphone 315-1. TSE 1 325 may transfer the first target voice to VAD 1 330 and the ASR 335. VAD 1 330 may detect the start of the first target voice and the end of the first target voice. VAD 1 330 may transfer the start and the end of the detected first target voice to the ASR 335.

According to an embodiment, AEC 2 320-1 may cancel at least some echoes from the second audio and transfer second audio data from which at least some echoes are cancelled to TSE 2 325-1. TSE 2 325-1 may extract (or generate) a second target voice from the second audio data. The second target voice includes only an improved user's voice and may be a voice from which at least some of the sounds except for the user's voice are cancelled. TSE 2 325-1 may extract the second target voice on the basis of the first audio data acquired through the first microphone 315. TSE 2 325-1 may transfer the second target voice to VAD 2 330-1 and the ASR 335. VAD 2 330-1 may detect the start of the second target voice and the end of the second target voice. VAD 2 330-1 may transfer the detected start and end of the second target voice to the ASR 335.

According to an embodiment, the ASR 335 may recognize the first target voice on the basis of the start of the first target voice and the end of the first target voice. The ASR 335 may recognize the first target voice and generate first translation information. The first translation information may be text. The ASR 335 may transfer the first translation information to the translation manager 345 via the translator 34. The translation manager 345 may transfer the first translation information to the TTS 350 or the display module 160 in order to output the same. The TTS 350 may convert the first translation information into a first translation voice and transfer the first translation voice to the second speaker 310-1. The second speaker 310-1 may output the first translation voice. Since the first translation information is for the user, the first translation voice may be output to the second speaker 310-1 facing the user. The display module 160 may display the first translation information.

According to an embodiment, the ASR 335 may recognize the second target voice on the basis of the start of the second target voice and the end of the second target voice. The ASR 335 may recognize the second target voice and generate second translation information. The second translation information may be text. The ASR 335 may transfer the second translation information to the translation manager 345. The translation manager 345 may transfer the second translation information to the TTS 350 or the display module 160 in order to output the same. The TTS 350 may convert the second translation information into a second translation voice and transfer the second translation voice to the first speaker 310. The first speaker 310 may output the second translation voice. Since the second translation information is for the counterpart, the second translation voice may be output to the first speaker 310 facing the counterpart. The display module 160 may display the second translation information.

An electronic device (for example, the electronic device 101 of FIG. 1) according to an embodiment of the disclosure may include at least one microphone (for example, the first microphone 315 of FIG. 3A), at least one speaker (for example, the first speaker 310 of FIG. 3A), a communication module (for example, the communication module 190 of FIG. 1), a display (for example, the display module 160 of FIG. 1), a memory (for example, the memory 130 of FIG. 1), and a processor (for example, the processor 120 of FIG. 1) operatively connected to at least one of the at least one microphone, the at least one speaker, the communication module, the display, or the memory, and the processor may be configured to acquire first audio through the at least one microphone that is connected with an external device (for example, the wireless input/output device 201 of FIG. 1) through the communication module, generate first audio data by cancelling at least some of echo (or an echo) from the acquired first audio, transmit the first audio data to the external device, receive one of second audio or second audio data acquired through a microphone (for example, the second microphone 360 of FIG. 3A) of the external device from the external device, translate each of the first audio data and the second audio data, and transmit first translation information obtained by translating the first audio data to the external device and output second translation information obtained by translating the second audio data.

The processor may be configured to generate the first audio data by inputting the first audio and a sound output through the at least one speaker into an acoustic echo canceller (AEC) as a first audio reference and cancelling at least some of sounds output through the at least one speaker from the first audio.

When second audio for which an AEC is not processed is received from the external device, the processor may be configured to generate the second audio data from which at least some echoes are cancelled by processing an AEC.

The processor may be configured to extract a first target voice from the first audio data by preprocessing the first audio data, based on the second audio data.

The processor may be configured to extract a counterpart's voice improved by cancelling at least some of sounds except for a counterpart's voice from the first audio data as the first target voice.

The processor may be configured to extract the first target voice from the first audio, based on user's voice information stored in the memory.

The electronic device may further include a camera module (for example, the camera module 180 of FIG. 1), and the processor may be configured to detect a start of the first target voice and an end of the first target voice by capturing a counterpart through the camera module and analyzing lip reading of a captured counterpart image.

The processor may be configured to detect a start of the first target voice and an end of the first target voice, perform automatic speech recognition (ASR) on the first target voice, based on the start of the first target voice and the end of the first target voice, and acquire first translation information by translating first text for which the ASR has been performed.

The processor may be configured to convert the first translation information into a first translation voice by using text to speech (TTS) and output the first translation voice through a speaker of the external device by transmitting the first translation voice to the external device.

The processor may be configured to receive a second target voice extracted from the second audio data and a start of the second target voice and an end of the second target voice from the external device.

The second target voice may include a user's voice improved by cancelling at least some of sounds except for a user's voice from the second audio data, and the start of the second target voice and the end of the second target voice may be detected through a voice pick-up (VPU) sensor included in the external device.

The processor may be configured to perform ASR on the second target voice, based on the start of the second target voice and the end of the second target voice and acquire second translation information by translating a second text on which the ASR is performed.

The processor may be configured to convert the second translation information into a second translation voice by using TTS and display the second translation information on the display or output the second translation voice to the at least one speaker.

The processor may be configured to acquire third audio through the at least one microphone while a first translation voice obtained by translating the first audio is output through the external device.

The processor may be configured to output second translation information obtained by translating the second audio through the at least one speaker while the external device acquires fourth audio.

FIG. 4 is a flowchart illustrating a method of providing a translation service in the state in which an electronic device and a wireless input/output device are connected according to an embodiment of the disclosure.

In the following embodiments, respective operations may be sequentially performed but the sequential performance is not necessary. For example, orders of the operations may be changed, and at least two operations may be performed in parallel.

Referring to FIG. 4, in operation 401, an electronic device (for example, the electronic device 101 of FIG. 1) and an external device (for example, the wireless input/output device 201 of FIG. 2) according to an embodiment may be connected. The electronic device 101 and the wireless input/output device 201 may be connected through Bluetooth via a communication module (for example, the communication module 190 of FIG. 1). In the state in which the user of the electronic device 101 is wearing the wireless input/output device 201, the user may execute an application for the translation service in order to talk to a foreigner. After being connected with the wireless input/output device 201, the electronic device 101 may execute the application (for example, the application 146 of FIG. 1) for the translation service according to a user input.

In operation 403, the electronic device 101 may acquire first audio input into a microphone (for example, the first microphone 315 of FIG. 3A). The electronic device 101 may acquire the first audio on the basis of a user input (for example, selection of a start button) through the application. Alternatively, the electronic device 101 may acquire the first audio by detecting whether a voice input after the application is executed. The first audio may include a counterpart's voice, a user's voice, surrounding noise, and/or a sound output from the first speaker 310. The first audio may be a user's voice or a counterpart's voice. The first audio may be stored in a first audio buffer (For example, the memory 130 of FIG. 1) of the electronic device 101. The memory 130 may store user's voice information (for example, an audio file or voice characteristic information related to a user's voice) of the electronic device 101. The electronic device 101 may determine whether the first audio is a user's voice or a counterpart's voice on the basis of the user's voice information stored in the memory 130. Hereinafter, it is described that the first audio is a voice acquired from the counterpart.

According to an embodiment, the electronic device 101 may generate first audio data by cancelling at least some echoes from the first audio. The electronic device 101 may generate the first audio data by applying AEC to the first audio. When cancelling the echo, the electronic device 101 may use a sound output through a speaker (for example, the first speaker 310 of FIG. 3A) of the electronic device 101 as a first audio reference. When there is a sound (for example, a voice translated for a user's voice, music, and/or a notification sound) being output through the first speaker 310, some of the sound being output through the first speaker 310 may flow into the first microphone 315. There may be a time difference until the sound output from the first speaker 310 is input into the first microphone 315. The electronic device 101 may cancel at least some of the sound output from the first speaker 310 from the first audio on the basis of the first audio reference. Further, the electronic device 101 may cancel at least some of the surrounding noise from the first audio.

In operation 405, the wireless input/output device 201 may acquire second audio input into a microphone (for example, the second microphone 360 of FIG. 3A). The second audio may include a counterpart's voice, a user's voice, surrounding noise, a sound output from the first speaker 310, and/or a sound output from a speaker (for example, the second speaker 365 of FIG. 3A) of the wireless input/output device 201. The second audio may be stored in a second audio buffer of the wireless input/output device 201. The wireless input/output device 201 may generate second audio data by applying AEC to the second audio. The wireless input/output device 201 may use the sound output from the first speaker 310 and/or the sound output from the second speaker 365 of the wireless input/output device 210 as a second audio reference. Some of the sound output from the first speaker 310 (for example, a voice translated for the user's voice) or the sound being output through the second speaker 365 (for example, a voice translated for the counterpart's voice, music, and/or a notification sound) may flow into the second microphone 360. The wireless input/output device 201 may cancel at least some of the sound output from the first speaker 310 and the sound being output through the second speaker 365 from the second audio on the basis of the second audio reference. Further, the wireless input/output device 201 may cancel at least some of the surrounding noise from the second audio.

In the drawings, operation 405 is performed after operation 403, but operation 403 and operation 405 may be performed in parallel or operation 403 may be first performed after operation 405. The drawings are only for understanding of the disclosure, and the disclosure is not limited by the drawings.

In operation 407, the electronic device 101 may transmit the first audio data to the wireless input/output device 201. The electronic device 101 may transmit the first audio data to the wireless input/output device 201 through a communication module (for example, the communication module 190 of FIG. 1).

In operation 409, the wireless input/output device 201 may transmit the second audio data to the electronic device 101. The wireless input/output device 201 may transmit the second audio data to the electronic device 101 through a communication module (for example, the communication module 190 of FIG. 1). According to an embodiment, the wireless input/output device 201 may transmit second audio (for example, raw data) to the electronic device 101 without generating second audio data. In this case, the wireless input/output device 201 may transmit the second audio to the electronic device 101. The operation for generating the second audio data can be omitted.

In the drawings, operation 407 is performed after operation 405, but may be performed between operation 403 and operation 405. Further, operation 409 may be performed between operation 405 and operation 407.

In operation 411, the electronic device 101 may preprocess the first audio data. Preprocessing the first audio data may be extracting a first target voice from the first audio data. The first target voice may include only an improved counterpart's voice and be a voice from which at least some of the sounds except for the counterpart's voice (for example, a user's voice) are cancelled. The electronic device 101 may extract the first target voice on the basis of the second audio data. Since the second audio data is a user's voice, the electronic device 101 may extract the first target voice by cancelling at least some of the user's voice from the counterpart's voice. Alternatively, the memory (for example, the memory 130 of FIG. 1) may store user's voice information of the electronic device 101 (for example, an audio file or voice characteristic information related to the user's voice). The electronic device 101 may extract the first target voice on the basis of the user's voice information stored in the memory 130. According to an embodiment, the electronic device 101 may extract the first target voice by using a machine learning or deep learning technology.

According to an embodiment, the electronic device 101 may detect the start of the first target voice and the end of the first target voice by using VAD (for example, VAD 1 330 of FIGS. 3A to 3C). According to an embodiment, the electronic device 101 may detect the start of the first target voice and the end of the first target voice by using a camera (for example, the camera module 180 of FIG. 1). For example, when an application for a translation service is executed, the electronic device 101 may operate the camera module 180 (for example, turn on the camera) to acquire an image from the camera module 180 and perform lip reading analysis for the acquired image to detect the start of the first target voice and the end of the first target voice.

In operation 413, the wireless input/output device 201 may preprocess the second audio data. Preprocessing the second audio data may be extracting a second target voice from the second audio data. The second target voice includes only an improved user's voice and may be a voice from which at least some of the sounds (for example, counterpart's voice) except for the user's voice are cancelled. The wireless input/output device 201 may extract the second target voice on the basis of the first audio data. Since the first audio data is a counterpart's voice, the wireless input/output device 201 may extract the second target voice by cancelling at least some of the counterpart's voice from the user's voice. The wireless input/output device 201 may detect the start of the second target voice and the end of the second target voice by using the VAD.

In operation 415, the wireless input/output device 201 may transmit the preprocessed second audio data. The preprocessed second audio data may include the second target voice and the start of the second target voice and the end of the second target voice.

In operation 417, the electronic device 101 may translate the preprocessed first audio data. For example, the electronic device 101 may recognize (for example, ASR) the first target voice on the basis of the start of the first target voice and the end of the first target voice. The electronic device 101 may generate first translation information by recognizing the first target voice. The first translation information may be text. The electronic device 101 may convert (for example, TTS) the first translation information into a first translation voice.

In operation 419, the electronic device 101 may transmit the first translation information to the wireless input/output device 201. The first translation information may include the first translation voice.

In operation 421, the electronic device 101 may translate the preprocessed second audio data. For example, the electronic device 101 may recognize the second target voice on the basis of the start of the second target voice and the end of the second target voice. The electronic device 101 may generate second translation information by recognizing the second target voice. The second translation information may be text. The electronic device 101 may convert the second translation information into a second translation voice.

In operation 423, the wireless input/output device 201 may output the first translation information. The first translation information is generated by translating the counterpart's voice, and thus may be for the user. Since the user is wearing the wireless input/output device 201, the first translation voice may be output to the second speaker 365 of the wireless input/output device 201.

In the drawings, operation 423 is performed before operation 425, but operation 423 may be performed in parallel with operation 421 or operation 425.

In operation 425, the electronic device 101 may output the second translation information. The second translation information may include the second translation voice. The second translation information may be generated by translating the user's voice and thus may be for the counterpart. The electronic device 101 may output the second translation voice through the first speaker 310 or display the second translation information on a display module (for example, the display module 160 of FIG. 1).

FIG. 5A illustrates an example in which each of an electronic device and a wireless input/output device acquires a voice according to an embodiment of the disclosure.

Referring to FIG. 5A, an electronic device (for example, the electronic device 101 of FIG. 1) and an external device (for example, the wireless input/output device 201 of FIG. 2) according to an embodiment may be connected to each other. The electronic device 101 and the wireless input/output device 201 may be connected through Bluetooth via a communication module (for example, the communication module 190 of FIG. 1). In the state in which the user of the electronic device 101 is wearing the wireless input/output device 201, the user may talk to a foreigner (for example, a counterpart). The user may be located close to the foreigner, and the electronic device 101 may be closer to the counterpart.

According to an embodiment, when the user speaks as indicated by reference numeral 510, the wireless input/output device 201 is relatively closer to a position of user speaking (for example, mouth) than the electronic device 101 is, and thus a volume 511 of a user's voice (for example, Hello) input into the wireless input/output device 201 may be larger than a volume 513 of a user's voice input into the electronic device 101. On the other hand, when the counterpart speaks as indicated by reference numeral 530, the electronic device 101 is relatively closer to the position of user speaking (for example, mouth) than the wireless input/output device 201 is, and thus a volume 531 of a counterpart's voice (for example, Hello) input into the electronic device 101 may be larger than a volume 533 of a counterpart's voice input into the wireless input/output device 201.

According to an embodiment, although the wireless input/output device 201 and the electronic device 101 are separated from each other, if the separation distance is not sufficient, some of the user's voice may flow into the first microphone of the electronic device 101 and some of the counterpart's voice may flow into the second microphone of the wireless input/output device 201. Alternatively, the sound being output through the first speaker of the electronic device 101 may flow into the first microphone of the electronic device 101 or the second microphone of the wireless input/output device 201. Further, the sound being output through the second speaker of the wireless input/output device 201 may flow into the second microphone of the wireless input/output device 201.

The electronic device 101 may share counterpart's voice data input into the first microphone with the wireless input/output device 201, and the wireless input/output device 201 may share user's voice data input into the second microphone with the electronic device 101. The electronic device 101 may separate and use only the counterpart's voice and the user's voice required for translation on the basis of the shared voices.

FIG. 5B illustrates an example in which each of an electronic device and a wireless input/output device acquires and outputs a voice according to an embodiment of the disclosure.

Referring to FIG. 5B, in the state in which a user of an electronic device (for example, the electronic device 101 of FIG. 1) according to an embodiment is wearing an external device (for example, the wireless input/output device 201 of FIG. 2), the user may talk to a foreigner (for example, a counterpart). In a chronological description for helping understanding of the disclosure, after a first user speaks indicated by a reference numeral 501, a first translation voice 503 for the first user speaking may be output through the electronic device 101. The first translation voice 503 may be output while the first user speaking 501 is acquired. Thereafter, first counterpart's voice data 505 may be acquired through the electronic device 101, and a second translation voice 507 for the first counterpart's voice data may be output through the wireless input/output device 201. The second translation voice 507 may be output while the first counterpart's voice data 505 is acquired. The wireless input/output device 201 may acquire second user's voice data 509 while the second translation voice 507 is output.

According to an embodiment, the electronic device 101 or the wireless input/output device 201 may display the current states for seamless conversation between the user and the counterpart. For example, for the current states, the electronic device 101 may display an idle mode and the wireless input/output device 201 may display an LED corresponding to a speaking mode in a first color (for example, green color) while the user speaks. Further, the electronic device 101 may display an output mode and the wireless input/output device 201 may display an LED corresponding to an idle mode in a second color (for example, red color) while the user's voice is translated and output. The electronic device 101 may display the speaking mode and the wireless input/output device 201 may display the LED corresponding to the idle mode in the second color while the counterpart speaks. The electronic device 101 may display the idle mode and the wireless input/output device 201 may display the LED corresponding the output mode in a third color (for example, an orange color) while the counterpart's voice is translated and output.

According to an embodiment, the electronic device 101 may preprocess (for example, extract a target voice) the voice acquired while the translated voice is output through the speaker, so as to separate and translate only a voice which should be translated. Even when the translated voice and the user's voice or the counterpart's voice overlap, the electronic device 101 may separate and translate only a target voice, so as to provide a relatively accurate translation service.

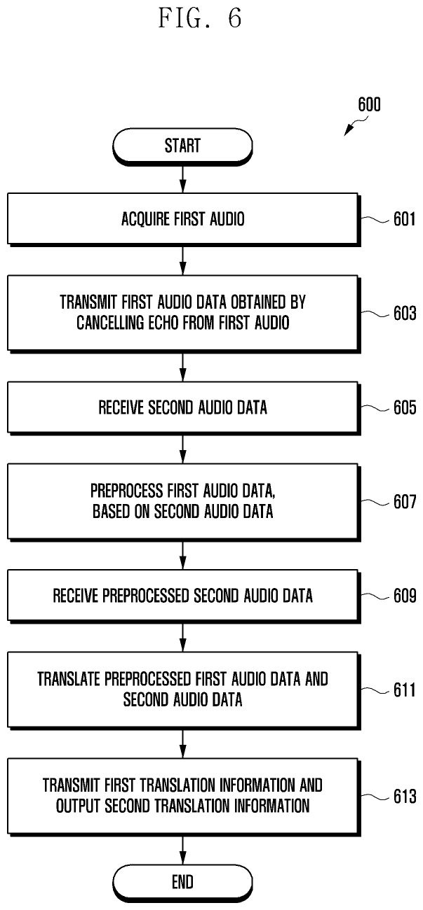

FIG. 6 is a flowchart 600 illustrating a method of operating an electronic device according to an embodiment of the disclosure.

In the following embodiments, respective operations may be sequentially performed but the sequential performance is not necessary. For example, orders of the operations may be changed, and at least two operations may be performed in parallel.

According to an embodiment, operations 601 to 613 may be understood as being performed by a processor (for example, the processor 120 of FIG. 1) of an electronic device (for example, the electronic device 101 of FIG. 1).

Referring to FIG. 6, in operation 601, the processor (for example, the processor 120 of FIG. 1) of the electronic device (for example, the electronic device 101 of FIG. 1) according to an embodiment may acquire first audio input into a microphone (for example, the first microphone 315 of FIG. 3A) in the state in which the electronic device is connected to an external device (for example, wireless input/output device 201 of FIG. 2). The processor 120 may acquire the first audio on the basis of a user input (for example, selection of a start button) through an application (for example, the application 146 of FIG. 1). Alternatively, the processor 120 may acquire the first audio by recognizing whether a voice is input after the application is executed. The first audio may include a counterpart's voice, a user's voice, surrounding noise, and/or a sound output from the first speaker 310. The first audio may be a user's voice or a counterpart's voice. A memory (for example, the memory 130 of FIG. 1) may store user's voice information (for example, an audio file or voice characteristic information related to the user's voice) of the electronic device 101. The processor 120 may determine whether the first audio is a user's voice or a counterpart's voice on the basis of the user's voice information stored in the memory 130. Hereinafter, it is described that the first audio is a voice acquired from the counterpart.

In operation 603, the processor 120 may transmit first audio data obtained by cancelling at least some echoes from the first audio to the wireless input/output device 201 through a communication module (for example, the communication module 190 of FIG. 1). The processor 120 may generate the first audio data by applying AEC (for example, AEC 1 320 of FIGS. 3A to 3C) to the first audio. When cancelling the echo, the processor 120 may use a sound output through a speaker (for example, the first speaker 310 of FIG. 3A) of the electronic device 101 as a first audio reference. There is a sound (for example, a voice translated for a user's voice, music, and/or a notification sound) being output through the first speaker 310, some of the sound being output through the first speaker 310 may flow into the first microphone 315. There may be a time difference until the sound output from the first speaker 310 is input into the first microphone 315. The processor 120 may cancel at least some of the sound output from the first speaker 310 from the first audio on the basis of the first audio reference. Further, the processor 120 may cancel at least some of the surrounding noise from the first audio.

In operation 605, the processor 120 may receive second audio data (or second audio) from the wireless input/output device 201. The second audio data is audio information acquired from the wireless input/output device 201 and may include, for example, data to which AEC is applied or AEC is not applied (for example, second audio or raw data). When the AEC is not applied, the processor 120 may generate second audio data by applying the AEC to the second audio. When cancelling the echo, the processor 120 may use the sound output from the first speaker 310 or the sound output from the second speaker 365 of the wireless input/output device 201 as a second audio reference. Some of the sound output from the first speaker 310 (for example, a voice translated for the counterpart's voice) or the sound being output through the second speaker 365 (for example, a voice translated for the counterpart's voice, music, and/or a notification sound) may flow into the second microphone 360. The processor 120 may cancel at least some of the sound output from the first speaker 310 and the sound being output through the second speaker 365 on the basis of the second audio reference. Further, the processor 120 may cancel at least some of the surrounding noise from the second audio.

In operation 607, the processor 120 may preprocess the first audio data on the basis of the second audio data. Preprocessing the first audio data may be extracting a first target voice from the first audio data. The first target voice may include only an improved counterpart's voice and be a voice from which at least some of the sounds except for the counterpart's voice (for example, a user's voice) are cancelled. The processor 120 may extract a first target voice on the basis of the second audio data. Since the second audio data is the user's voice, the processor 120 may extract the first target voice by cancelling at least some of the user's voice from the counterpart's voice. The processor 120 may extract the first target voice on the basis of user's voice information stored in the memory 130. According to an embodiment, the processor 120 may extract the first target voice by using a machine learning or deep learning technology.

The processor 120 may detect the start of the first target voice and the end of the first target voice by using VAD (for example, VAD 1 330 of FIGS. 3A to 3C). According to an embodiment, the processor 120 may detect the start of the first target voice and the end of the first target voice by using a camera (for example, the camera module 180 of FIG. 1). For example, when an application for a translation service is executed, the processor 120 may operate the camera module 180 (for example, turn on the camera) to acquire an image from the camera module 180 and perform lip reading analysis for the acquired image to detect the start of the first target voice and the end of the first target voice.

In operation 609, the processor 120 may receive the preprocessed second audio data from the wireless input/output device 201 through the communication module 190. The preprocessed second audio data may include the second target voice and the start of the second target voice and the end of the second target voice. The second target voice includes only an improved user's voice and may be a voice from which at least some of the sounds (for example, counterpart's voice) except for the user's voice are cancelled.

In operation 611, the processor 120 may translate the preprocessed first audio data and second audio data. The processor 120 may recognize (for example, ASR) the first target voice on the basis of the start of the first target voice and the end of the first target voice. The processor 120 may generate first translation information by recognizing the first target voice. The first translation information may be text. The processor 120 may convert (for example, TTS) the first translation information into a first translation voice. Further, the processor 120 may recognize the second target voice on the basis of the start of the second target voice and the end of the second target voice. The processor 120 may generate second translation information by recognizing the second target voice. The second translation information may be text. The processor 120 may convert the second translation information into the second translation voice.

In the drawings, the first audio data and the second audio data are translated at once in operation 611, but the first audio data may be translated and transmitted among operation 603 to operation 609. Alternatively, the second audio data may be translated and transmitted among operation 603 to operation 609.

In operation 613, the processor 120 may transmit the first translation information and output the second translation information. The first translation information is generated by translating the counterpart's voice, and thus may be for the user. Since the user is wearing the wireless input/output device 201, the first translation voice may be output to the second speaker 365 of the wireless input/output device 201. The second translation information may be generated by translating the user's voice and thus may be for the counterpart. The processor 120 may output the second translation voice through the first speaker 310 or display the second translation information on a display module (for example, the display module 160 of FIG. 1).

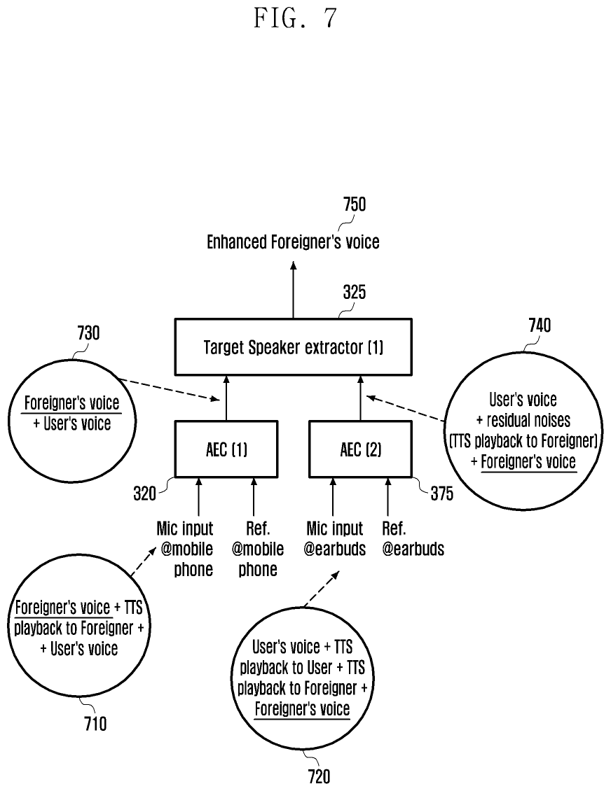

FIG. 7 illustrates an example in which an electronic device preprocesses and translates a counterpart's voice according to an embodiment of the disclosure.

Referring to FIG. 7, an electronic device (for example, the electronic device 101 of FIG. 1) and a wireless input/output device (for example, the wireless input/output device 201 of FIG. 2) according to an embodiment may be connected. The electronic device 101 and the wireless input/output device 201 may be connected through Bluetooth via a communication module (for example, the communication module 190 of FIG. 1). In the state in which the user of the electronic device 101 is wearing the wireless input/output device 201, the user may execute an application (for example, the application 146 of FIG. 1) for the translation service in order to easily talk to a foreigner. When first audio is acquired through a microphone (for example, the first microphone 315 of FIG. 3A) of the electronic device 101, first audio 710 may be input into AEC 1 320 of the electronic device 101. The first audio 710 may include a counterpart's voice (for example, a foreigner's voice), a user's voice (for example, a user's voice), surrounding noise, and/or a sound output from the first speaker 310 (for example, TTS playback to foreigner). AEC 1 320 may cancel at least some of the surrounding noise and the sound output from the first speaker 310 and output the counterpart's voice (for example, foreigner's voice) and the user's voice (for example, user's voice). An output 730 of AEC 1 320 is first audio data and may be an input of TSE 1 325.

According to an embodiment, when second audio is acquired through a microphone (for example, the second microphone 360 of FIG. 3A) of the wireless input/output device 201, second audio 720 may be input into AEC 2 375 of the wireless input/output device 201. The second audio 720 may include a counterpart's voice (for example, foreigner's voice), a user's voice (for example, user's voice), surrounding noise, a sound output from the first speaker 310 (for example, TTS playback to foreigner), or a sound output from the second speaker (for example, the second speaker 365 of FIG. 3A) (for example, TTS playback to user). AEC 2 375 may cancel at least some of the surrounding noise, the sound output from the first speaker 310, and sound output from the second speaker 365 and output the counterpart's voice (for example, foreigner's voice) and the user's voice (for example, user's voice). An output 740 of AEC 2 375 is second audio data and may be an input of TSE 1 325. According to an embodiment, the output 740 of AEC 2 375 may include some noise (for example, residual noises).

According to an embodiment, AEC 1 320 of the electronic device 101 may receive the second audio 720 and output the second audio data.

According to an embodiment, TSE 1 325 may preprocess the first audio data on the basis of the second audio data. For example, TSE 1 325 may extract a first target voice 750 (for example, enhanced foreigner's voice) by cancelling at least some of the user's voice from the counterpart's voice. The electronic device 101 may recognize the first target voice and process translation.

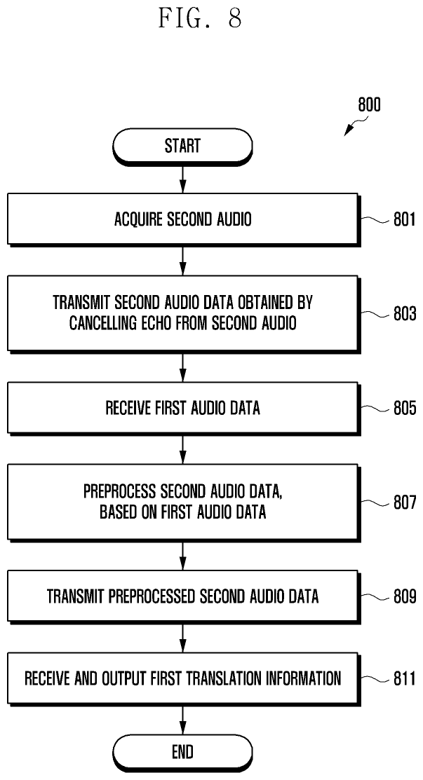

FIG. 8 is a flowchart 800 illustrating a method of operating a wireless input/output device according to an embodiment of the disclosure.

In the following embodiments, respective operations may be sequentially performed but the sequential performance is not necessary. For example, orders of the operations may be changed, and at least two operations may be performed in parallel.

According to an embodiment, operations 801 to 813 may be understood as being performed by a processor (for example, the second processor 301 of FIG. 3A) of an external device (for example, the wireless input/output device 201 of FIG. 2).

Referring to FIG. 8, in the estate in which a processor (for example, the second processor 301 of FIG. 3A) of an external device (for example, the wireless input/output device 201 of FIG. 2) according to an embodiment is connected to an electronic device (for example, the electronic device 101 of FIG. 1) and the external device is worn on the user, second audio input into a microphone (for example, the second microphone 360 of FIG. 3A) may be acquired in operation 801. The wireless input/output device 201 may be connected (for example, Bluetooth) with the electronic device 101 through a communication module (for example, the communication module 190 of FIG. 1). In the state in which the user is wearing the wireless input/output device 201, the user may talk to a foreigner. The second audio may include a counterpart's voice, a user's voice, surrounding noise, a sound output from a first speaker (for example, the first speaker 310 of FIG. 3A) of the electronic device 101, and/or a sound output from a speaker (for example, the second speaker 365 of FIG. 3A) of the wireless input/output device 201. The second audio may be a user's voice.

In operation 803, the processor 301 may transmit second audio data obtained by cancelling at least some echoes from the second audio to the electronic device 101. The processor 301 may generate second audio data by applying AEC (for example, AEC 2 380 of FIG. 3A) to the second audio. The processor 301 may use the sound output from the first speaker 310 or the sound output from the second speaker 365 of the wireless input/output device 201 as a second audio reference. Some of the sound output from the first speaker 310 (for example, a voice translated for the counterpart's voice) or the sound output through the second speaker 365 (for example, a voice translated for the counterpart's voice, music, and/or a notification sound) may flow into the second microphone 360. The processor 301 may cancel at least some of the sound output from the first speaker 310 and the sound being output through the second speaker 365 on the basis of the second audio reference. Further, the processor 301 may cancel at least some of the surrounding noise from the second audio.

In operation 805, the processor 301 may receive first audio data from the electronic device 101. The first audio data may be obtained by applying AEC to the first audio (for example, the counterpart's voice).

In operation 807, the processor 301 may preprocess the second audio data on the basis of the first audio data. Preprocessing the second audio data may be extracting a second target voice from the second audio data. The second target voice includes only an improved user's voice and may be a voice from which at least some of the sounds (for example, counterpart's voice) except for the user's voice are cancelled. The processor 301 may extract a second target voice on the basis of the second audio data. Since the first audio data is the counterpart's voice, the processor 301 may extract the second target voice by cancelling at least some of the counterpart's voice from the user's voice. According to an embodiment, the processor 301 may extract the second target voice by using a machine learning or deep learning technology. The processor 301 may detect the start of the second target voice and the end of the second target voice by using VAD.

In operation 809, the processor 301 may transmit the preprocessed second audio data to the electronic device 101 through the communication module 190. The preprocessed second audio data may include the second target voice and the start of the second target voice and the end of the second target voice. The second target voice includes only an improved user's voice and may be a voice from which at least some of the sound (for example, counterpart's voice) except for the user's voice are cancelled.

In operation 811, the processor 301 may receive and output first translation information. The first translation information is generated by translating the counterpart's voice, and thus may be for the user. Since the user is wearing the wireless input/output device 201, the first translation voice may be output to the second speaker 365 of the wireless input/output device 201.

Although operation 811 is described as the last operation, operation 811 may be performed between operation 805 and operation 809. Further, a new user's voice may be acquired from the user after operation 801.

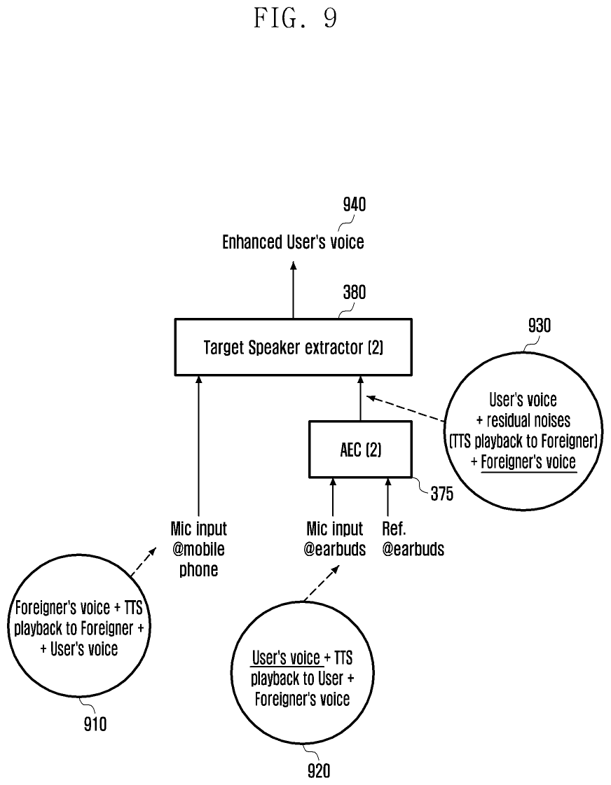

FIG. 9 illustrates an example in which a wireless input/output device preprocesses and translates a user's voice according to an embodiment of the disclosure.

Referring to FIG. 9, an external device (for example, the wireless input/output device 201 of FIG. 2) according to an embodiment may be connected to an electronic device (for example, the electronic device 101 of FIG. 1). The electronic device 101 and the wireless input/output device 201 may be connected through Bluetooth via a communication module (for example, the communication module 190 of FIG. 1). In the state in which the user of the electronic device 101 is wearing the wireless input/output device 201, the user may start talking to a foreigner. When second audio is acquired through a microphone (for example, the first microphone 315) of the wireless input/output device 201, second audio 920 may be input into AEC 2 375 of the wireless input/output device 201. The second audio 720 may include a counterpart's voice (for example, a foreigner's voice), a user's voice (for example, a user's voice), surrounding noise, and/or a sound output from the second speaker 365 (for example, TTS playback to user). AEC 2 375 may cancel at least some of the surrounding noise and the sound output from the second speaker 365 and output the counterpart's voice (for example, foreigner's voice) and the user's voice (for example, user's voice). An output 930 of AEC 2 375 is second audio data and may be input into TSE 2 380. According to an embodiment, the output 740 of AEC 2 375 may include some noise (for example, residual noises).

According to an embodiment, when first audio is acquired through a microphone (for example, the first microphone 310 of FIG. 3A) of the electronic device 101, the first audio may be input into TSE 2 380. The first audio 910 may include a counterpart's voice (for example, a foreigner's voice), a user's voice (for example, a user's voice), surrounding noise, and/or a sound output from the first speaker 310 (for example, TTS playback to foreigner). The wireless input/output device 201 may model the user's voice by using the first audio (for example, raw data) to which AEC is not applied by the electronic device 101.

According to an embodiment, TSE 2 380 may preprocess the second audio data on the basis of the first audio data (or first audio 910). For example, TSE 2 380 may extract a second target voice 940 (for example, enhanced user's voice) by cancelling at least some of the counterpart's voice from the user's voice. TSE 2 380 may transmit the second target voice to the electronic device 101 through the communication module, and the electronic device 101 may recognize and translate the second target voice.

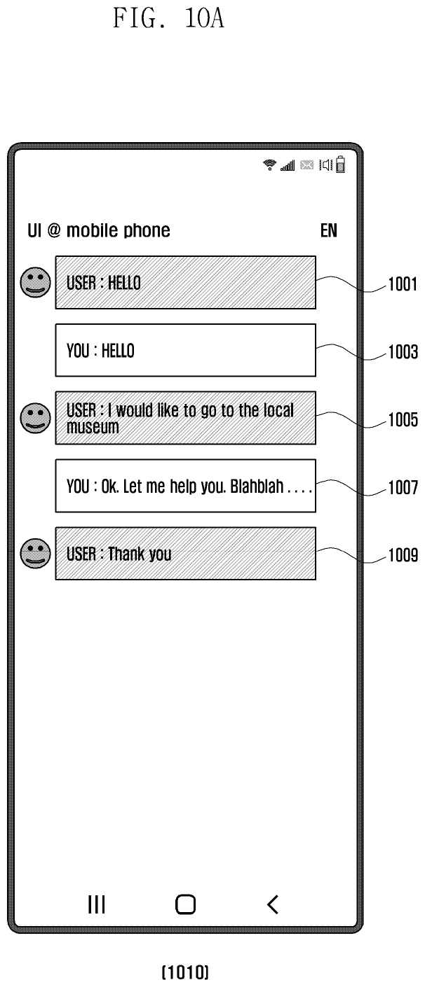

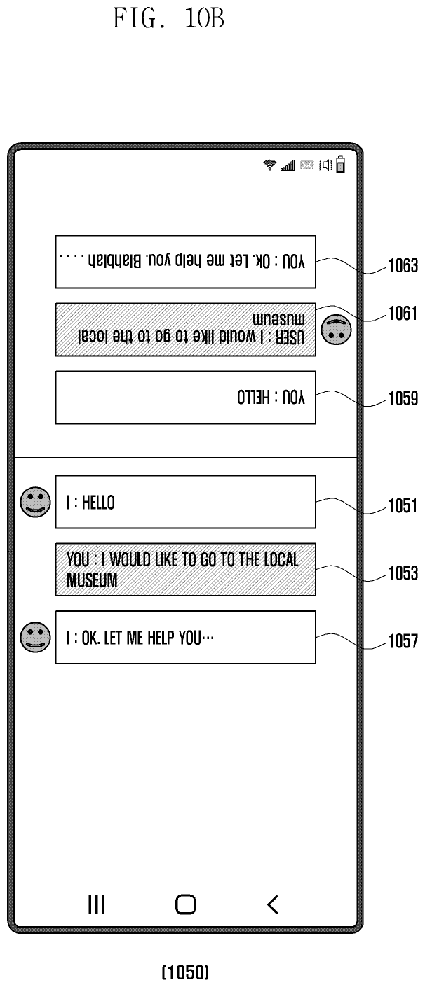

FIGS. 10A and 10B illustrate user interfaces provided by an electronic device according to an embodiment of the disclosure.

Referring to FIG. 10A, in the state in which a processor (for example, the processor 120 of FIG. 1) of an electronic device (for example, the electronic device 101 of FIG. 1) according to an embodiment is connected to an external device (for example, the wireless input/output device 201 of FIG. 2) and the user is wearing the wireless input/output device 201, a first user interface 1010 for a translation service may be provided. The first user interface 1010 is for a counterpart, and conversation between the user (for example, you) and the counterpart (for example, user) may be displayed in language corresponding to the counterpart. Alternatively, the first user interface 1010 may display conversation between the user (for example, you) and the counterpart (for example, user) in language corresponding to the user. For example, the processor 120 may display a first counterpart (user) utterance 1001 on the basis of a first counterpart's voice and display a first user utterance 1003 obtained by translating a first user's voice. The first user utterance 1003 may be output through a speaker (for example, the first speaker 310 of FIG. 3A) of the electronic device 101.

According to an embodiment, the processor 120 may display a second counterpart utterance 1005 on the basis of a second counterpart's voice and output translation corresponding to the second counterpart utterance 1005 (for example, I would like to go to the local museum) to the wireless input/output device 201 in the form of a voice. The second counterpart utterance 1005 may be displayed on the basis of voice recognition. The processor 120 may display a second user utterance 1007 obtained by translating a second user's voice and display a third counterpart utterance 1009 on the basis of a third counterpart's voice. For example, since the user is speaking in a user's mother tongue (for example, Korean), the processor 120 may translate the second user's voice into a counterpart's mother tongue. The second user utterance 1007 may be output through the first speaker 310.

Referring to FIG. 10B, the processor 120 of the electronic device 101 may provide a second user interface 1050. The second user interface 1050 may be an embodiment of providing the translation service in the state in which the electronic device 101 is not connected to the wireless input/output device 201. Alternatively, it may be an embodiment of providing the translation service in the state in which the electronic device 101 is connected to the wireless input/output device 201. The second user interface may include chat windows (for example, 1059, 1061, and 1063) for the counterpart at the location closer to the counterpart than the user and chat windows (for example, 1051, 1053, and 1057) for the user at the location closer to the user than the counterpart. The processor 120 may display different languages in the counterpart chat window and the user chat window.

According to an embodiment, the processor 120 may display first counterpart content 1059 and first user content 1051 in response to a first user's voice, display second counterpart content 1061 and second user content 1053 in response to a first counterpart's voice, and display third counterpart content 1063 and third user content 1057 in response to a second user's voice. The counterpart content and the user content may correspond to each other but displayed languages may be different.

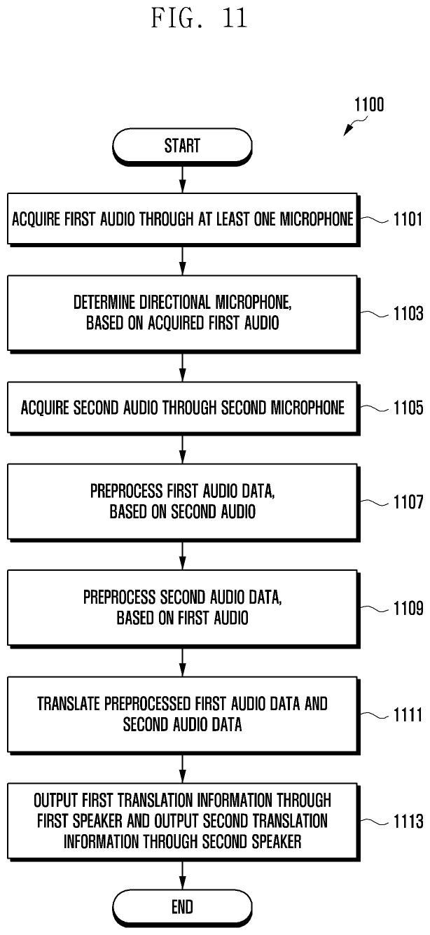

FIG. 11 is a flowchart illustrating a method by which an electronic device acquires and translates a user's voice and a counterpart's voice according to an embodiment of the disclosure.

In the following embodiments, respective operations may be sequentially performed but the sequential performance is not necessary. For example, orders of the operations may be changed, and at least two operations may be performed in parallel.

According to an embodiment, operations 1101 to 1113 may be understood as being performed by a processor (for example, the processor 120 of FIG. 1) of an electronic device (for example, the electronic device 101 of FIG. 1).

Referring to FIG. 11, in operation 1101, a processor (for example, the processor 120 of FIG. 1) of an electronic device (for example, the electronic device 101 of FIG. 1) according to an embodiment may acquire first audio through at least one microphone. The processor 120 may execute an application (for example, the application 146 of FIG. 1) for translation according a user request and acquire the first audio through the application. The electronic device 101 may include at least one of a first speaker (for example, the first speaker 310 of FIG. 3C), a second speaker (for example, the second speaker 310-1 of FIG. 3C), a first microphone (for example, the first microphone 315 of FIG. 3C), or a second microphone (for example, the second microphone 315-1 of FIG. 3C).

According to an embodiment, the first speaker 310 and the first microphone 315 may be located at substantially similar locations, and the second speaker 310-1 and the second microphone 315-1 may be disposed at separated locations. For example, the first speaker 310 and the first microphone 315 may be disposed on one end of the electronic device 101 (for example, a direction in which the camera is disposed) from the front of the electronic device 101 on which a display (for example, the display module 160 of FIG. 1) of the electronic device 101 is disposed, and the second speaker 310-1 and the second microphone 315-1 may be disposed on the other end of the electronic device 101 (for example, a direction to which a charger is connected). Alternatively, the first speaker 310 and the first microphone 315 may be disposed on one side of the electronic device 101 (for example, the left side in a viewpoint of the user viewing the electronic device 101) from the front of the electronic device 101, and the second speaker 310-1 and the second microphone 315-1 may be disposed on the other side (for example, the right side) of the electronic device 101.

According to an embodiment, the first audio may be a user's voice or a counterpart's voice. A memory (for example, the memory 130 of FIG. 1) may store user's voice information (for example, an audio file or voice characteristic information related to the user's voice) of the electronic device 101. The processor 120 may determine whether the first audio is a user's voice or a counterpart's voice on the basis of the user's voice information stored in the memory 130.

In operation 1103, the processor 120 may determine a directional microphone on the basis of the acquired first audio. The processor 120 may determine a microphone heading for the first audio on the basis of the volume of the first audio acquired from the first microphone 315 and the volume of the first audio acquired from the second microphone 315-1. The volume of the sound acquired from each microphone may be different according to the location of the microphone close to the counterpart or the user. For example, when the counterpart is located closer to the first microphone 315 than the second microphone 315-1, the volume of a first audio signal acquired from the first microphone 315 may be larger than the volume of a first audio signal acquired from the second microphone 315-1. The processor 120 may determine the microphone heading for the first audio as the first microphone 315 on the basis of the volume of the first audio acquired from the first microphone 315 and the volume of the first audio acquired from the second microphone 315-1.

Hereinafter, it is described that the first audio is a voice acquired from the counterpart. The processor 120 may generate first audio data by applying AEC (for example, AEC 1 320 of FIG. 3C) to the first audio.

In operation 1105, the processor 120 may acquire second audio through the second microphone 315-1. The processor 120 may determine a directional microphone of the second audio having a voice characteristic different from that of the first audio as the second microphone 315-1. Hereinafter, it is described that the counterpart is located closer to the first speaker 310 and the first microphone 315 than the user is and the user is located closer to the second speaker 310-1 and the second microphone 315-1 than the counterpart is. It is described that the second audio is a voice acquired from the user. The processor 120 may generate second audio data by applying AEC to the second audio.

In operation 1107, the processor 120 may preprocess the first audio data on the basis of the second audio. The second audio may be second audio data to which AEC is applied. The preprocessing may be extraction of a target voice. The processor 120 may extract (or generate) a first target voice from the first audio data on the basis of the second audio data. The first target voice includes only an improved counterpart's voice and may be a voice from which at least some of the sounds except for the counterpart's voice (for example, surrounding noise and the user's voice) are cancelled. The processor 120 may detect the start of the first target voice and the end of the first target voice.

In operation 1109, the processor 120 may preprocess the second audio data on the basis of the first audio. The first audio may be first audio data to which AEC is applied. The preprocessing may be extraction of a target voice. The processor 120 may extract (or generate) a second target voice from the second audio data on the basis of the first audio data. The second target voice includes only an improved user's voice and may be a voice from which at least some of the sound (for example, surrounding noise and the user's voice) except for the user's voice are cancelled. The processor 120 may detect the start of the second target voice and the end of the second target voice.

Operation 1107 and operation 1108 may be performed in parallel, or operation 1108 may be performed earlier than operation 1107.

In operation 1111, the processor 120 may translate the preprocessed first audio data and second audio data. The processor 120 may recognize the first target voice on the basis of the start of the first target voice and the end of the first target voice. The processor 120 may generate first translation information by recognizing the first target voice. The first translation information may be text. The processor 120 may convert the first translation information into a first translation voice or transfer the first translation information to the display module 160. The processor 120 may recognize the second target voice on the basis of the start of the second target voice and the end of the second target voice. The processor 120 may generate second translation information by recognizing the second target voice. The second translation information may be text. The processor 120 may convert the second translation information into the second translation voice or transfer the second translation information to the display module 160.

In operation 1113, the processor 120 may output the second translation information through the first speaker 310 and output the first translation information through the second speaker 310-1. The counterpart may be located closer to the first speaker 310 than the user is, and the user may be located closer to the second speaker 310-1 than the counterpart is. The processor 120 may translate the counterpart's voice input through the first microphone 315 and output the translated counterpart's voice through the second speaker 310-1. The processor 120 may translate the user's voice input through the second microphone 315-1 and output the translated user's voice through the first speaker 310.

A method of operating an electronic device according to an embodiment of the disclosure may include an operation of acquiring first audio through the at least one microphone of the electronic device that is connected with an external device through the communication module of the electronic device, an operation of generating first audio data by cancelling at least some of echo (or an echo) from the acquired first audio, an operation of transmitting the first audio data to the external device, an operation of receiving one of second audio or second audio data acquired through a microphone of the external device from the external device, an operation of translating each of the first audio data and the second audio data, and an operation of transmitting first translation information obtained by translating the first audio data to the external device and outputting second translation information obtained by translating the second audio data.

The operation of generating may include an operation of generating the first audio data by inputting the first audio and a sound output through the at least one speaker into an acoustic echo canceller (AEC) as a first audio reference and cancelling at least some of sounds output through the at least one speaker from the first audio.

The operation of translating may include an operation of extracting a first target voice from the first audio data by preprocessing the first audio data, based on the second audio data, an operation of detecting a start of the first target voice and an end of the first target voice, an operation of performing ASR on the first target voice, based on the start of the first target voice and the end of the first target voice, and an operation of acquiring first translation information by translating first text for which the ASR has been performed.

The operation of transmitting the first translation information may include an operation of converting the first translation information into a first translation voice by using TTS and an operation of outputting the first translation voice through a speaker of the external device by transmitting the first translation voice to the external device.

The method may further include an operation of receiving a second target voice extracted from the second audio data and a start of the second target voice and an end of the second target voice from the external device, an operation of performing ASR on the second target voice, based on the start of the second target voice and the end of the second target voice, an operation of acquiring second translation information by translating a second text on which the ASR is performed, an operation of converting the second translation information into a second translation voice by using TTS, and an operation of displaying the second translation information on the display or output the second translation voice to the at least one speaker.

The electronic device according to certain embodiments may be one of various types of electronic devices. The electronic devices may include, for example, a portable communication device (e.g., a smart phone), a computer device, a portable multimedia device, a portable medical device, a camera, a wearable device, or a home appliance. According to an embodiment of the disclosure, the electronic devices are not limited to those described above.

It should be appreciated that certain embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Certain embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to certain embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to certain embodiments, each component (e.g., a module or a program) of the above-described components may include a single entity or multiple entities, and some of the multiple entities may be separately disposed in different components. According to certain embodiments, one or more of the above-described components may be omitted, or one or more other components may be added. Alternatively or additionally, a plurality of components (e.g., modules or programs) may be integrated into a single component. In such a case, according to certain embodiments, the integrated component may still perform one or more functions of each of the plurality of components in the same or similar manner as they are performed by a corresponding one of the plurality of components before the integration. According to certain embodiments, operations performed by the module, the program, or another component may be carried out sequentially, in parallel, repeatedly, or heuristically, or one or more of the operations may be executed in a different order or omitted, or one or more other operations may be added.

One or more embodiments of the disclosure disclosed in the specifications and drawings present specific examples for ease of description of the technical content of the disclosure and to help understanding of the disclosure, but are not intended to limit the scope of the disclosure. Therefore, it should be construed that not only the embodiments disclosed herein but also all modifications or modified forms capable of being derived on the basis of the technical idea of the disclosure are included in the scope of the disclosure.

What is claimed is:

1. An electronic device comprising:
at least one microphone;
at least one speaker;
a communication module;
a display;
a memory; and
a processor operatively connected to at least one of the at least one microphone, the at least one speaker, the communication module, the display, or the memory,
wherein the processor is configured to:
acquire first audio through the at least one microphone being connected with an external device through the communication module;
generate first audio data by cancelling an echo from the acquired first audio;
transmit the first audio data to the external device;
receive at least one of second audio or second audio data, the second audio or the second audio data being acquired through a microphone of the external device from the external device;
translate the first audio data and obtain first translation information;
translate the second audio data and obtain second translation information;
transmit the first translation information to the external device; and
output the second translation information.

2. The electronic device of claim 1, wherein the processor is further configured to generate the first audio data by inputting the first audio and a sound output into an acoustic echo canceller (AEC) as a first audio reference and by cancelling a portion of the sound output, the sound output being received through the at least one speaker from the first audio.

3. The electronic device of claim 1, wherein the processor is further configured to, based on a second audio for which an acoustic echo canceller (AEC) is not processed being received from the external device, generate the second audio data from which a portion of echoes is cancelled by processing an AEC.

4. The electronic device of claim 1, wherein the processor is further configured to extract a first target voice from the first audio data by preprocessing the first audio data based on the second audio data.

5. The electronic device of claim 4, wherein the processor is further configured to extract a counterpart's voice improved by cancelling at least a portion of sounds except for a counterpart's voice from the first audio data as the first target voice.

6. The electronic device of claim 4, wherein the processor is further configured to extract the first target voice from the first audio, based on information of a user's voice, the information being stored in the memory.

7. The electronic device of claim 4, further comprising a camera module, wherein the processor is further configured to detect a start of the first target voice and an end of the first target voice by capturing a counterpart through the camera module and analyzing a captured counterpart image.

8. The electronic device of claim 4, wherein the processor is further configured to:
detect a start of the first target voice and an end of the first target voice;
perform automatic speech recognition (ASR) on the first target voice, based on the start of the first target voice and the end of the first target voice; and
acquire first translation information by translating first text for which the ASR has been performed.

9. The electronic device of claim 8, wherein the processor is further configured to:
convert the first translation information into a first translation voice by using text-to-speech (TTS); and
output the first translation voice through a speaker of the external device by transmitting the first translation voice to the external device.

10. The electronic device of claim 1, wherein the processor is further configured to receive a second target voice extracted from the second audio data and a start of the second target voice and an end of the second target voice from the external device.

11. The electronic device of claim 10, wherein the second target voice comprises a user's voice improved by cancelling at least a portion of sounds except for the user's voice from the second audio data, and
wherein the start of the second target voice and the end of the second target voice are detected through a voice pick-up (VPU) sensor of the external device.

12. The electronic device of claim 10, wherein the processor is further configured to:
perform ASR on the second target voice, based on the start of the second target voice and the end of the second target voice; and
acquire second translation information by translating a second text on which the ASR is performed.

13. The electronic device of claim 12, wherein the processor is further configured to:
convert the second translation information into a second translation voice by using text-to-speech (TTS); and
display the second translation information on the display or output the second translation voice to the at least one speaker.

14. The electronic device of claim 1, wherein the processor is further configured to:
acquire third audio through the at least one microphone; and
obtain a first translation voice by translating the first audio is output through the external device.

15. The electronic device of claim 1, wherein the processor is further configured to output second translation information obtained by translating the second audio through the at least one speaker when the external device acquires fourth audio.

16. A method of operating an electronic device, the method comprising:
acquiring first audio through the at least one microphone of the electronic device being connected with an external device through the communication module of the electronic device;
generating first audio data by cancelling an echo from the acquired first audio;
transmitting the first audio data to the external device;
receiving at least one of second audio or second audio data, the second audio or the second audio data being acquired through a microphone of the external device from the external device;
translating each of the first audio data and the second audio data; and
transmitting first translation information obtained by translating the first audio data to the external device and outputting second translation information obtained by translating the second audio data.

17. The method of claim 16, wherein the generating the first audio data comprises generating the first audio data by inputting the first audio and a sound output through at least one speaker into an acoustic echo canceller (AEC) as a first audio reference and by cancelling at least a portion of sounds output through the at least one speaker from the first audio.

18. The method of claim 16, wherein the translating each of the first audio data and the second audio data comprises:
extracting a first target voice from the first audio data by preprocessing the first audio data based on the second audio data;
detecting a start of the first target voice and an end of the first target voice;
performing automatic speech recognition (ASR) on the first target voice, based on the start of the first target voice and the end of the first target voice; and
acquiring first translation information by translating a first text on which the ASR has been performed.

19. The method of claim 18, wherein the transmitting of the first translation information comprises:
converting the first translation information into a first translation voice by using TTS; and
outputting the first translation voice through a speaker of the external device by transmitting the first translation voice to the external device.

20. The method of claim 16, further comprising:
receiving a second target voice extracted from the second audio data and a start of the second target voice and an end of the second target voice from the external device;
performing automatic speech recognition (ASR) on the second target voice, based on the start of the second target voice and the end of the second target voice;
acquiring second translation information by translating a second text on which the ASR is performed;
converting the second translation information into a second translation voice by using text-to-speech (TTS); and
displaying the second translation information on the display or output the second translation voice to the at least one speaker.
